(19) United States
(12) Patent Application Publication
(10) Pub. No.: US 2005/0177749 A1
(43) Pub. Date: Aug. 11, 2005

(54) Method and architecture for security key generation and distribution within optical switched networks

(76) Inventor: Shlomo Ovadia, San Jose, CA (US)

Correspondence Address: R. Alan Burnett;BLAKELY, SOKOLOFF, TAYLOR & ZAFMAN LLP, Seventh Floor, 12400 Wilshire Boulevard, Los Angeles, CA, 90025, US

(21) Appl. No.: 10/804,487

(22) Filed: Mar. 18, 2004

Related U.S. Application Data
(63) Continuation-in-part of application No. 10/774,813, filed on Feb. 9, 2004.

(51) Int. Cl. H04L 9/00

(52) U.S. Cl. 713/201

(57) ABSTRACT

A method and architecture for secure transmission of data within optical-switched networks. In one embodiment, the optical switched network comprises a photonic burst-switched (PBS) network. Under various schemes, security keys including encryption and decryption keys are generated by edge nodes and the decryption keys are distributed to other edge nodes in a PBS network. In one embodiment, the security keys are dynamically generated by a trusted platform module (TPM). A source edge node uses its encryption key to encrypt selected data bursts to be sent to a destination edge node via a virtual lightpath coupling the source and destination edge nodes. Security data are embedded in a control burst header indicates to the destination node whether corresponding data bursts sent via the virtual lightpath are encrypted. The security data also includes the decryption key and may also identify an encryption/decryption algorithm to be used. In some embodiments, public key infrastructure facilities are used in conjunction with employment of private and public keys and digital certificates.

### CROSS REFERENCE TO RELATED APPLICATIONS

The present application is a continuation-in-part of U.S. patent application Ser. No. 10/774,813 (Attorney Docket No. 42P18636) entitled “METHOD AND ARCHITECTURE FOR SECURE TRANSMISSION OF DATA WITHIN OPTICAL SWITCHED NETWORKS,” filed Feb. 9, 2004, the benefit of the priority date of which is claimed under U.S.C. 35 § 120. The present application is also related to U.S. patent application Ser. No. 8/126,091, filed Apr. 17, 2002; U.S. patent application Ser. No. 8/183,111, filed Jun. 25, 2002; U.S. patent application Ser. No. 10/328,571, filed Dec. 24, 2002; U.S. patent application Ser. No. 8/377,312 filed Feb. 28, 2003; U.S. patent application Ser. No. 8/377,580 filed Feb. 28, 2003; U.S. patent application Ser. No. 8/417,823 filed Apr. 16, 2003; U.S. patent application Ser. No. 8/417,487 filed Apr. 17, 2003; U.S. patent application Ser. No. 10/441,771 (Attorney Docket No. 42P16183) filed May 19, 2003, U.S. patent application Ser. No. 10/464,969 (Attorney Docket No. 42P16552) filed Jun. 18, 2003, U.S. patent application Ser. No. 10/606,323 (Attorney Docket No. 42P16847) filed Jun. 24, 2003, U.S. patent application Ser. No. 10/636,062 (Attorney Docket No. 42P17373) filed Aug. 6, 2003, and U.S. patent application Ser. No. 10/691,712 (Attorney Docket No. 42P17541) filed Oct. 22, 2003.

### FIELD OF THE INVENTION

Embodiments of the present invention relate to optical networks in general; and, more specifically, to techniques for secure transmission of data with optical switched networks.

### BACKGROUND INFORMATION

Transmission bandwidth demands in telecommunication networks (e.g., the Internet) appear to be ever increasing and solutions are being sought to support this bandwidth demand. One solution to this problem is to use fiber-optic networks, where wavelength-division-multiplexing (WDM) technology enables the same physical link to transport multiple pieces of data concurrently.

Conventional optical switched networks typically use wavelength routing techniques, which require that optical-electrical-optical (O-E-O) conversion of optical signals be done at the optical switches. O-E-O conversion at each switching node in the optical network is not only a very slow operation (typically about ten milliseconds), but it is very costly, and potentially creates a traffic bottleneck for the optical switched network. In addition, the current optical switch technologies cannot efficiently support “bursty” traffic that is often experienced in packet communication applications (e.g., the Internet).

A large communication network can be implemented using several sub-networks. For example, a large network to support Internet traffic can be divided into a large number of relatively small access networks operated by Internet service providers (ISPs), which are coupled to a number of metropolitan area networks (Optical MANs), which are in turn coupled to a large “backbone” wide area network (WAN). The optical MANs and WANs typically require a higher bandwidth than local-area networks (LANs) in order to provide an adequate level of service demanded by their high-end users. Furthermore, as LAN speeds/bandwidth increase with improved technology, there is a corresponding need for increasing MAN/WAN speeds/bandwidth.

Recently, optical burst switching (OBS) schemes have emerged as a promising solution to support high-speed bursty data traffic over WDM optical networks. The OBS scheme offers a practical opportunity between the current optical circuit-switching and the emerging all optical packet switching technologies. It has been shown that under certain conditions, the OBS scheme achieves high-bandwidth utilization and class-of-service (CoS) by elimination of electronic bottlenecks as a result of the O-E-O conversion occurring at switching nodes, and by using a one-way end-to-end bandwidth reservation scheme with variable time slot duration provisioning scheduled by the ingress nodes. Optical switching fabrics are attractive because they offer at least one or more orders of magnitude lower power consumption with a smaller form factor than comparable O-E-O switches. However, most of the recently published work on OBS networks focuses on the next-generation backbone data networks (i.e. Internet wide network) using high capacity (i.e., 1 Tb/s) WDM switch fabrics with a large number of input/output ports (i.e., 256×256), optical channels (i.e., 40 wavelengths), and requiring extensive buffering. Thus, these WDM switches tend to be complex and very expensive to manufacture. In contrast, there is a growing demand to support a wide variety of bandwidth-demanding applications such as storage and/or server area networks (SANs) and multimedia multicast at a low cost for both local and wide-area networks.

Another important aspect of communication networks is security. While attacks on servers and the like have gained much notoriety recently, there are other security concerns relating to the transport of data itself. For example, “packet-sniffing” techniques in the like may be used to “steal” messages and/or data. While various techniques are currently being used to secure communication networks, none of these techniques have been applied to optical burst-switched networks due to the difference in how data is transmitted across optical burst-switched networks when compared with conventional communication networks.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a simplified block diagram illustrating a photonic burst-switched (PBS) network with variable time slot provisioning, according to one embodiment of the present invention;

FIG. 2 is a simplified flow diagram illustrating the operation of a photonic burst-switched (PBS) network, according to one embodiment of the present invention;

FIG. 3 is a block diagram illustrating a switching node module for use in a photonic burst-switched (PBS) network, according to one embodiment of the present invention;

FIG. 4 is a diagram illustrating PBS optical burst flow between nodes in a PBS network, according to one embodiment of the present invention;

FIG. 5 is a diagram illustrating generic PBS framing format for PBS optical bursts, according to one embodiment of the present invention;

FIG. 6 is a diagram illustrating further details of the PBS framing format of FIG. 5, according to one embodiment of the present invention.

FIG. 7 is a schematic diagram illustrating an integrated data and control-plane PBS software architecture with privacy management, according to one embodiment of the present invention;

FIG. 8a is a schematic diagram of a network infrastructure including a PBS network connected to multiple external networks;

FIG. 8b is a schematic diagram corresponding to the network infrastructure of FIG. 8a, wherein transmission routes in the PBS network are depicted as virtual lightpaths connecting a pair of edge nodes;

FIG. 8c is a schematic diagram corresponding to the network infrastructure of FIGS. 8a and 8b, showing further details of an exemplary set of virtual lightpaths connecting a pair of edge nodes, wherein a virtual lightpath comprises a concatenation of lightpath segments having the same or different wavelengths;

FIGS. 9a and 9b are schematic diagrams corresponding to the PBS network portion of the diagrams of FIGS. 8a-c, further illustrating an exemplary security key distribution scheme in which respective sets of asymmetric encryption/decryption keys are generated by PBS edge nodes and distributed to the other PBS edge nodes, according to one embodiment of the present invention;

FIG. 9c is a schematic diagram corresponding to the PBS network portion of the diagrams of FIGS. 8a-c, further illustrating a first exemplary security key distribution scheme implemented with PKI (Public Key Infrastructure) techniques, according to one embodiment of the present invention;

FIG. 9d is a schematic diagram corresponding to the PBS network portion of the diagrams of FIGS. 8a-c, illustrating a second exemplary security key distribution scheme implemented with PKI techniques.

FIG. 10a is a schematic diagram illustrating a mechanism for security storing a digital certificate or key at a PBS edge node, wherein the mechanism employs the use of a trusted platform module (TPM) which enables a secret to be sealed to the TPM;

FIG. 10b is a schematic diagram illustrating a mechanism for retrieving a digital certificate or key that was securely stored using the mechanism of FIG. 10a, wherein the mechanism employs a TPM_Unseal command to retrieve a secret comprising a symmetric key that is used to decrypted the securely-stored certificate or key;

FIG. 11a is a flowchart illustrating operations and logic performed during a process for securely
storing a key or digital certificate by implementation of the mechanism of FIG. 10a;

FIG. 11b is a flowchart illustrating operations and logic performed during a process for retrieving a securely-stored key or digital certificate by implementation of the mechanism of FIG. 10b;

FIG. 12 is a diagram illustrating a data structure for an exemplary extended header format including fields in which security data may be provided, according to one embodiment of the present invention;

FIG. 13a is a flowchart illustrating setup and ongoing operations corresponding to a secure data transmission process under which existing keys are held by various PBS edge nodes, according to one embodiment of the present invention;

FIG. 13b is a flowchart illustrating operations performed during a secure data transmission process under which keys are dynamically generated at a source edge node and security data used to decrypt data are forwarded to a destination edge node via a control burst, according to one embodiment of the present invention;

FIG. 14a is a block diagram illustrating an optical PBS I/O module, according to one embodiment of the present invention;

FIG. 14b is a block diagram illustrating in more details of the network processor unit and the queue unit depicted in FIG. 14a, according to one embodiment of the present invention;

FIG. 15 is a flow diagram illustrating an egress operational flow, according to one embodiment of the present invention; and

FIG. 16 is a flow diagram illustrating an egress operational flow, according to one embodiment of the present invention.

### DETAILED DESCRIPTION OF PREFERRED EMBODIMENTS

Embodiments of techniques for secure transmission of data bursts within optical switched networks are described herein. In the following description, numerous specific details are set forth, such as descriptions of embodiments that are implemented for photonic burst-switched (PBS) networks, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the following detailed descriptions, embodiments of the invention are disclosed with reference to their use in photonic burst-switched (PBS) networks. A PBS network is a type of optical-switched network, typically comprising a high-speed hop and span-constrained network, such as an enterprise network. The term “photonic burst” is used herein to refer to statistically-multiplexed data flows (e.g., Internet protocol (IP) packets, Ethernet frames, Fibre Channel (FC) frames) having similar routing requirements. Although conceptually similar to backbone-based optical burst-switched (OBS) networks, the design, operating-constraints, and performance requirements of these high-speed hop and span-constrained networks may be different. However, it will be understood that the teaching and principles disclosed herein may be applicable to other types of optical switched networks as well.

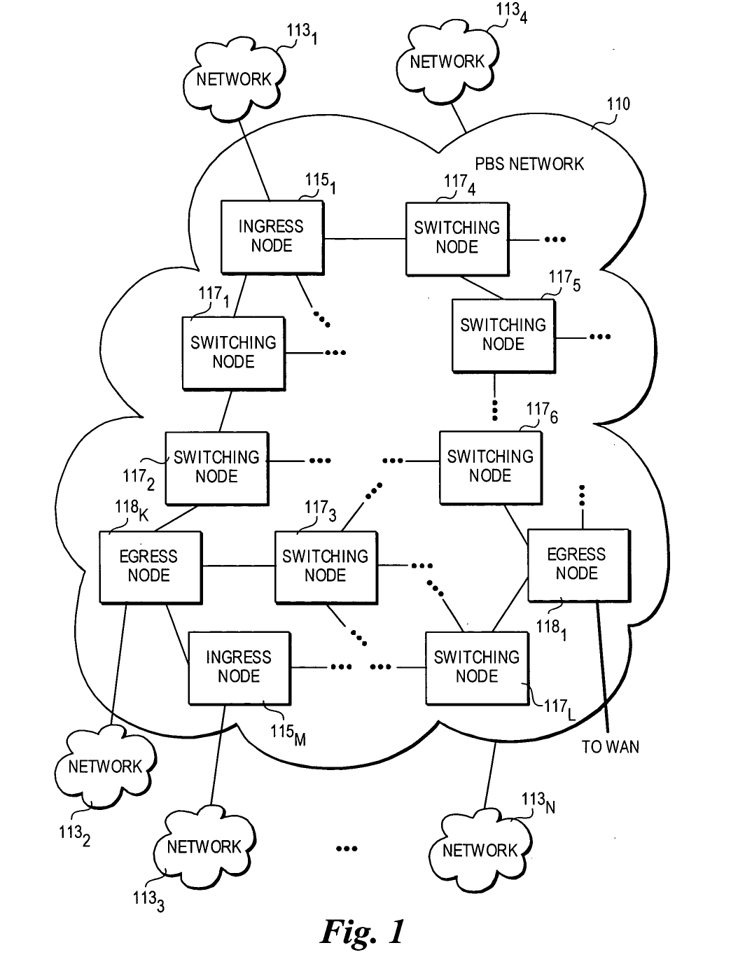

FIG. 1 illustrates an exemplary photonic burst-switched (PBS) network 110 in which embodiments of the invention described herein may be implemented. A PBS network is a type of optical switched network. This embodiment of PBS network 110 includes local area networks (LANs) 113₁-113_{N} and a backbone optical WAN (not shown). In addition, this embodiment of PBS network 110 includes ingress nodes 115₁-115_{M}, switching nodes 117₁-117_{L}, and egress nodes 118₁-118_{K}. PBS network 110 can include other ingress, egress and switching nodes (not shown) that are interconnected with the switching nodes shown in FIG. 1. The ingress and egress nodes are also referred to herein as edge nodes in that they logically reside at the edge of the PBS network. The edge nodes, in effect, provide an interface between the aforementioned “external” networks (i.e., external to the PBS network) and the switching nodes of the PBS network. In this embodiment, the ingress, egress and switching nodes are implemented with intelligent modules. This embodiment can be used, for example, as a metropolitan area network connecting a large number of LANs within the metropolitan area to a large optical backbone network.

In some embodiments, the ingress nodes perform optical-electrical (O-E) conversion of received optical signals, and include electronic memory to buffer the received signals until they are sent to the appropriate LAN/WAN. In addition, in some embodiments, the ingress nodes also perform electrical-optical (E-O) conversion of the received electrical signals before they are transmitted to switching nodes 117₁-117_{M} of PBS network 110.

Egress nodes are implemented with optical switching units or modules that are configured to receive optical signals from other nodes of PBS network 110 and route them to the optical WAN or other external networks. Egress nodes can also receive optical signals from the optical WAN or other external network and send them to the appropriate node of PBS network 110. In one embodiment, egress node 118₁ performs O-E-O conversion of received optical signals, and includes electronic memory to buffer received signals until they are sent to the appropriate node of PBS network 110 (or to the optical WAN).

Switching nodes 117₁-117_{L} are implemented with optical switching units or modules that are each configured to receive optical signals from other switching nodes and appropriately route the received optical signals to other switching nodes of PBS network 110. As is described below, the switching nodes perform O-E-O conversion of optical control bursts and network management control burst signals. In some embodiments, these optical control bursts and network management control bursts are propagated only on pre-selected wavelengths. The pre-selected wavelengths do not propagate optical “data” bursts (as opposed to control bursts and network management control bursts) signals in such embodiments, even though the control bursts and network management control bursts may include necessary information for a particular group of optical data burst signals. The control and data information is transmitted on separate wavelengths in some embodiments (also referred to herein as out-of-band (OOB) signaling). In other embodiments, control and data information may be sent on the same wavelengths (also referred to herein as in-band (IB) signaling). In another embodiment, optical control bursts, network management control bursts, and optical data burst signals may be propagated on the same wavelength(s) using different encoding schemes such as different modulation formats, etc. In either approach, the optical control bursts and network management control bursts are sent asynchronously relative to its corresponding optical data burst signals. In still another embodiment, the optical control bursts and other control signals are propagated at different transmission rates as the optical data signals.

Although switching nodes 117₁-117_{L} may perform O-E-O conversion of the optical control signals, in this embodiment, the switching nodes do not perform O-E-O conversion of the optical data burst signals. Rather, switching nodes 117₁-117_{L} perform purely optical switching of the optical data burst signals. Thus, the switching nodes can include electronic circuitry to store and process the incoming optical control bursts and network management control bursts that were converted to an electronic form and use this information to configure photonic burst switch settings, and to properly route the optical data burst signals corresponding to the optical control bursts. The new control bursts, which replace the previous control bursts based on the new routing information, are converted to an optical control signal, and it is transmitted to the next switching or egress nodes. Embodiments of the switching nodes are described further below.

Elements of exemplary PBS network 110 are interconnected as follows. LANs 113₁-113_{N} are connected to corresponding ones of ingress nodes 115₁-115_{M}. Within PBS network 110, ingress nodes 115₁-115_{M} and egress nodes 118₁-118_{K} are connected to some of switching nodes 117₁-117_{L} via optical fibers. Switching nodes 117₁-117_{L} are also interconnected to each other via optical fibers in mesh architecture to form a relatively large number of lightpaths or optical links between the ingress nodes, and between ingress nodes 115₁-115_{L} and egress nodes 118₁-118_{K}. Ideally, there are more than one lightpath to connect the switching nodes 117₁-117_{L} to each of the endpoints of PBS network 110 (i.e., the ingress nodes and egress nodes are endpoints within PBS network 110). Multiple lightpaths between switching nodes, ingress nodes, and egress nodes enable protection switching when one or more switching node fails, or can enable features such as primary and secondary routes to destination.

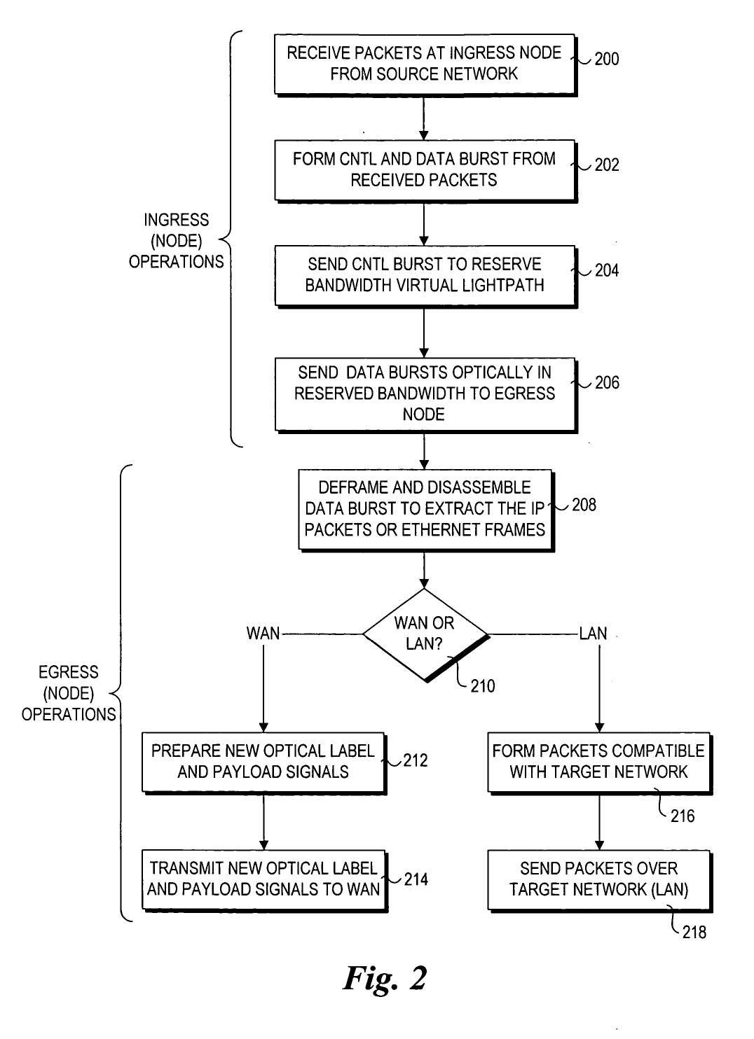

As described below in conjunction with FIG. 2, the ingress, egress and switching nodes of PBS network 110 are configured to send and/or receive optical control bursts, optical data burst, and other control signals that are wavelength multiplexed so as to propagate the optical control bursts and control labels on pre-selected wavelength(s) and optical data burst or payloads on different pre-selected wavelength(s). Still further, the edge nodes of PBS network 110 can send optical control burst signals while sending data out of PBS network 110 (either optical or electrical).

FIG. 2 illustrates the operational flow of PBS network 110, according to one embodiment of the present invention. Referring to FIGS. 1 and 2, photonic burst switching network 110 operates as follows.

The process begins in a block 200, wherein PBS network 110 receives packets from LANs 113₁-113_{N}. In one embodiment, PBS network 110 receives IP packets at ingress nodes 115₁-115_{M}. The received packets can be in electronic form rather than in optical form, or received in optical form and then converted to electronic form. In this embodiment, the ingress nodes store the received packets electronically.

For clarity, the rest of the description of the operational flow of PBS network 110 focuses on the transport of information from ingress node 115₁ to egress node 118₁. The transport of information from ingress nodes 115₂-115_{M} to egress node 118₁ (or other egress nodes) is substantially similar.

An optical burst label (i.e., an optical control burst) and optical payload (i.e., an optical data burst) is formed from the received packets, as depicted by a block 202. In one embodiment, ingress node 115₁ uses statistical multiplexing techniques to form the optical data burst from the received IP (Internet Protocol) packets stored in ingress node 115₁. For example, packets received by ingress node 115₁ and having to pass through egress node 118₁ on their paths to a destination can be assembled into an optical data burst payload.

Next, in a block 204, bandwidth on a specific optical channel and/or fiber is reserved to transport the optical data burst through PBS network 110. In one embodiment, ingress node 115₁ reserves a time slot (i.e., a time slot of a TDM system) in an optical data signal path through PBS network 110 using a control burst. This time slot may be fixed-time duration and/or variable-time duration with either uniform or non-uniform timing gaps between adjacent time slots. Further, in one embodiment, the bandwidth is reserved for a time period sufficient to transport the optical burst from the ingress node to the egress node. For example, in some embodiments, the ingress, egress, and switching nodes maintain an updated list of all used and available time slots. The time slots can be allocated and distributed over multiple wavelengths and optical fibers. Thus, a reserved time slot (also referred to herein as a TDM channel), which in different embodiments may be of fixed-duration or variable-duration, may be in one wavelength of one fiber, and/or can be spread across multiple wavelengths and multiple optical fibers.

In one embodiment, when an ingress and/or egress node reserves bandwidth using a control burst or when bandwidth is released after an optical data burst is transported, a network controller (not shown) updates the list. In one embodiment, the network controller and the ingress or egress nodes perform this updating process using various burst or packet scheduling algorithms based on the available network resources and traffic patterns. Generally, the network controller function can reside in one of the ingress or egress nodes, or can be distributed across two or more ingress and/or egress nodes.

The optical data bursts are then transported through photonic burst switching network 110 in the reserved time slot or TDM channel, as depicted by a block 206. In one embodiment, ingress node 115₁ transmits the control burst to the next node along the optical label-switched path (OLSP) determined by the network controller. In this embodiment, the network controller uses a constraint-based routing protocol [e.g., multi-protocol label switching (MPLS)] over one or more wavelengths to determine the best available OLSP to the egress node.

In one embodiment, the control label (also referred to herein as a control burst) is transmitted asynchronously ahead of the photonic data burst and on a different wavelength and/or different fiber. The time offset between the control burst and the data burst allows each of the switching nodes to process the label and configure the photonic burst switches to appropriately switch before the arrival of the corresponding data burst. The term photonic burst switch is used herein to refer to fast optical switches that do not use O-E-O conversion.

In one embodiment, ingress node 115₁ then asynchronously transmits the optical data bursts to the switching nodes where the optical data bursts experience little or no time delay and no O-E-O conversion within each of the switching nodes. The optical control burst is always sent before the corresponding optical data burst is transmitted.

In some embodiments, the switching node may perform O-E-O conversion of the control bursts so that the node can extract and process the routing information contained in the label. Further, in some embodiments, the TDM channel is propagated in the same wavelengths that are used for propagating labels. Alternatively, the labels and payloads can be modulated on the same wavelength in the same optical fiber using different modulation formats. For example, optical labels can be transmitted using non-return-to-zero (NRZ) modulation format, while optical payloads are transmitted using return-to-zero (RZ) modulation format on the same wavelength. The optical burst is transmitted from one switching node to another switching node in a similar manner until the optical control and data bursts are terminated at egress node 118₁.

The remaining set of operations pertains to egress node operations. Upon receiving the data burst, the egress node de-frames and disassembles it to extract the IP packets or Ethernet frames in a block 208. In one embodiment, egress node 118₁ converts the optical data burst to electronic signals that egress node 118₁ can process to recover the data segment of each of the packets. The operational flow at this point depends on whether the target network is an optical WAN or a LAN, as depicted by a decision block 210.

If the target network is an optical WAN, new optical label and payload signals are formed in a block 212. In this embodiment, egress node 118₁ prepares the new optical label and payload signals. The new optical label and payload are then transmitted to the target network (i.e., WAN in this case) in a block 214. In this embodiment, egress node 118₁ includes an optical interface to transmit the optical label and payload to the optical WAN.

However, if in decision block 210 the target network is determined to be a LAN, the logic proceeds to a block 216. Accordingly, the extracted IP data packets or Ethernet frames are processed, combined with the corresponding IP labels, and then routed to the target network (i.e., LAN in this case). In this embodiment, egress node 118₁ forms these new IP packets. The new IP packets are then transmitted to the target network (i.e., LAN) as shown in block 210.

PBS network 110 can achieve increased bandwidth efficiency through the additional flexibility afforded by the TDM channels. Although this exemplary embodiment described above includes an optical MAN having ingress, switching and egress nodes to couple multiple LANs to an optical WAN backbone, in other embodiments the networks do not have to be LANs, optical MANs or WAN backbones. That is, PBS network 110 may include a number of relatively small networks that are coupled to a relatively larger network that in turn is coupled to a backbone network.

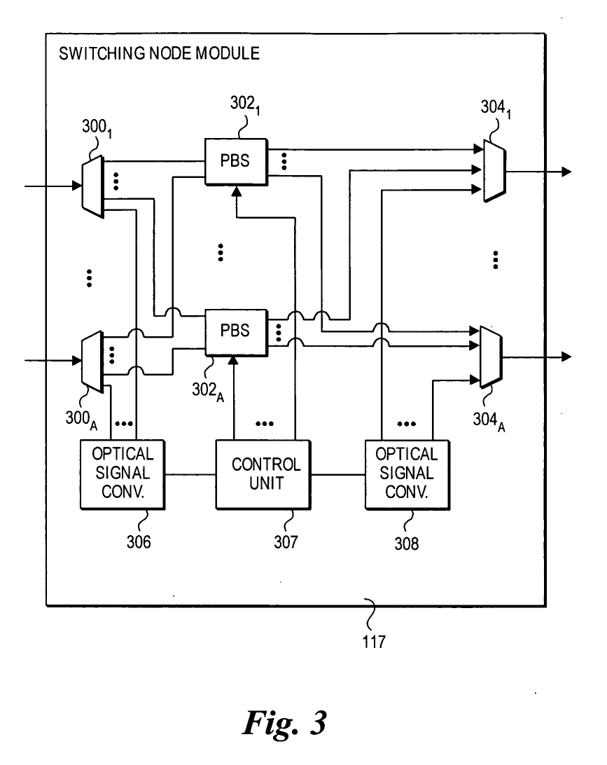

FIG. 3 illustrates a module 117 for use as a switching node in photonic burst switching network 110 (FIG. 1), according to one embodiment of the present invention. In this embodiment, module 117 includes a set of optical wavelength division demultiplexers 300₁-300_{A}, where A represents the number of input optical fibers used for propagating payloads, labels, and other network resources to the module. For example, in this embodiment, each input fiber could carry a set of C wavelengths (i.e., WDM wavelengths), although in other embodiments the input optical fibers may carry differing numbers of wavelengths. Module 117 would also include a set of N×N photonic burst switches 302₁-302_{B}, where N is the number of input/output ports of each photonic burst switch. Thus, in this embodiment, the maximum number of wavelengths at each photonic burst switch is A·C, where N≧A·C+1. For embodiments in which N is greater than A·C, the extra input/output ports can be used to loop back an optical signal for buffering.

Further, although photonic burst switches 302₁-302_{B} are shown as separate units, they can be implemented as N×N photonic burst switches using any suitable switch architecture. Module 117 also includes a set of optical wavelength division multiplexers 304₁-304_{A}, a set of optical-to-electrical signal converters 306 (e.g., photo-detectors), a control unit 307, and a set of electrical-to-optical signal converters 308 (e.g., lasers). Control unit 307 may have one or more processors to execute software or firmware programs.

The elements of this embodiment of module 117 are interconnected as follows. Optical demultiplexers 300₁-300_{A} are connected to a set of A input optical fibers that propagate input optical signals from other switching nodes of photonic burst switching network 110. The output leads of the optical demultiplexers are connected to the set of B core optical switches 302₁-302_{B} and to optical signal converter 306. For example, optical demultiplexer 300₁ has B output leads connected to input leads of the photonic burst switches 302₁-302_{B} (i.e., one output lead of optical demultiplexer 300₁ to one input lead of each photonic burst switch) and at least one output lead connected to optical signal converter 306.

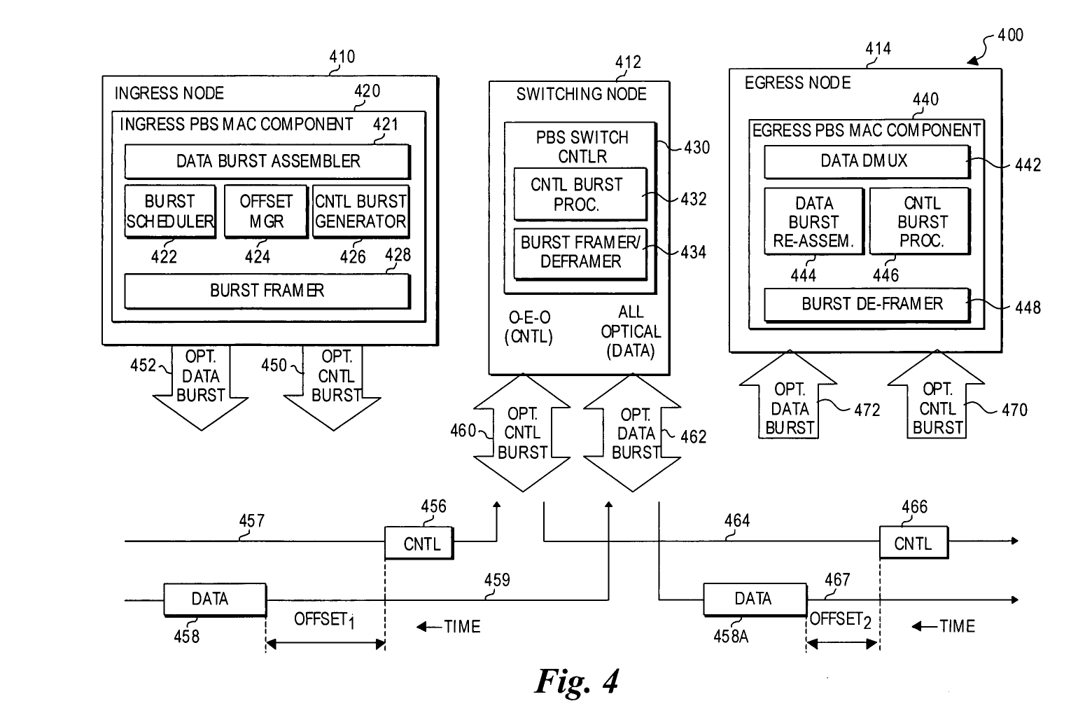

The output leads of photonic burst switches 302₁-302_{B} are connected to optical multiplexers 304₁-304_{A}. For example, photonic burst switch 302₁ has A output leads connected to input leads of optical multiplexers 304₁-304_{A} (i.e., one output lead of photonic burst switch 302₁ to one input lead of each optical multiplexer). Each optical multiplexer also an input lead connected to an output lead of electrical-to-optical signal converter 308. Control unit 307 has an input lead or port connected to the output lead or port of optical-to-electrical signal converter 306. The output leads of control unit 307 are connected to the control leads of photonic burst switches 302₁-302_{B} and electrical-to-optical signal converter 308. As described below in conjunction with the flow diagram of FIG. 4, module 117 is used to receive and transmit optical control bursts, optical data bursts, and network management control bursts.

FIG. 4 illustrates PBS optical burst flow between nodes under an exemplary PBS architecture 400, according to one embodiment of the present invention. Architecture 400 includes an ingress node 410, a switching node 412, an egress node 414 and other nodes (egress, switching, and ingress that are not shown to avoid obscuring the description of the optical burst flow). In this embodiment, the illustrated components of ingress, switching and egress nodes 410, 412 and 414 are implemented using machine-readable instructions that cause a machine (e.g., a processor) to perform operations that allow the nodes to transfer information to and from other nodes in the PBS network. In this example, the lightpath for the optical burst flow is from ingress node 410, to switching node 412 and then to egress node 414.

Ingress node 410 includes an ingress PBS MAC (Media Access Control) layer component 420 having a data burst assembler 421, a data burst scheduler 422, an offset time manager 424, a control burst generator 426 and a burst framer 428. In one embodiment, data burst assembler 421 assembles the data bursts to be optically transmitted over PBS network 110. In one embodiment, the size of the data burst is determined based on many different network parameters such as quality-of-service (QoS), number of available optical channels, the size of electronic buffering at the ingress nodes, the specific burst assembly algorithm, etc.

Data burst scheduler 422, schedules the data burst transmission over PBS network 110. Ingress PBS MAC layer component 410 generates a bandwidth request for insertion into the control burst associated with the data burst being formed. In one embodiment, data burst scheduler 422 also generates the schedule to include an offset time (from offset manager 424 described below) to allow for the various nodes in PBS network 110 to process the control burst before the associated data burst arrives.

In one embodiment, offset time manager 424 determines the offset time based on various network parameters such as, for example, the number of hops along the selected lightpath, the processing delay at each switching node, traffic loads for specific lightpaths, and class of service requirements. Then control burst generator 426 builds the control burst using information such as the required bandwidth, burst scheduling time, in-band or out-of-band signaling, burst destination address, data burst length, data burst channel wavelength, offset time, priorities, and the like.

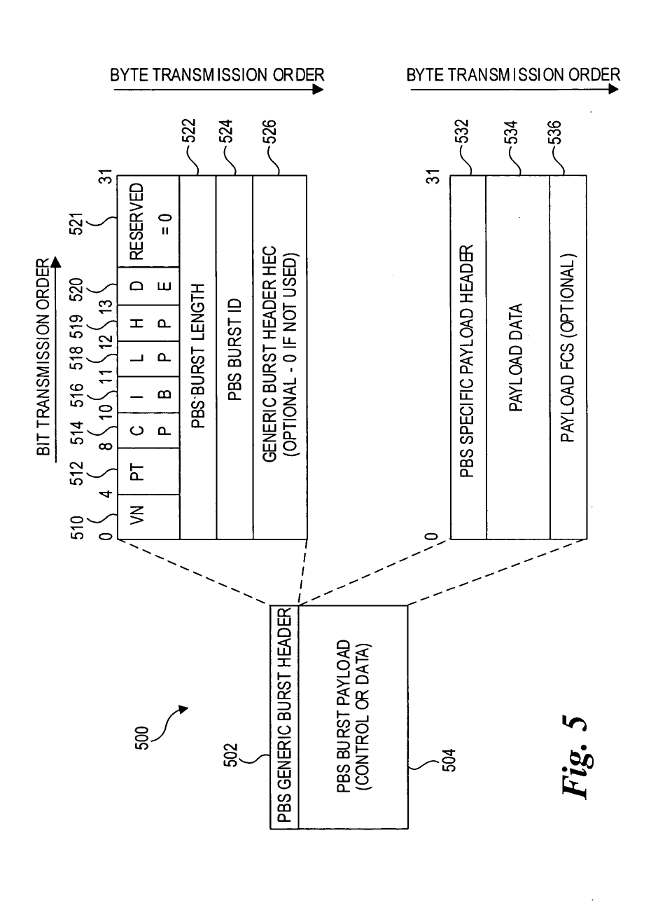

Burst framer 428 frames the control and data bursts (using the framing format described below in conjunction with FIGS. 5, 6, and 10 in some embodiments). Burst framer 428 then transmits the control burst over PBS network 110 via an electrical-to-optical

However, if the bandwidth can be found and reserved for the data burst, PBS switch controller component 430 appropriately configures the hardware PBS switch (not shown) for the scheduled data burst. In addition, PBS switch controller component 430 generates a new control burst based on the updated reserved bandwidth from control burst processing component 432 and the available PBS network resources. Control burst framer/de-framer 434 then frames the re-built control burst, which is then optically transmitted to egress node 414 via the physical optical interface (not shown) and the optical switch (not shown), as indicated by PBS TDM channel 464 and an optical control burst 466 in FIG. 4.

Subsequently, when the optical data burst corresponding to the received/processed control burst is received by switching node 412, the hardware PBS switch is already configured to switch the optical data burst to egress node 414. In other situations, switching node 412 can switch the optical data burst to a different node (e.g., another switching node not shown in FIG. 4). The optical data burst from ingress node 410 is then switched to egress node 414, as indicated by PBS TDM channel 467 and an optical data burst 458A. In this embodiment, optical data burst 458A is simply optical data burst 458 re-routed by the hardware PBS switch (not shown), but possibly transmitted in a different TDM channel. The time delay between optical control burst 466 and optical data burst 458A is indicated by an OFFSET₂ in FIG. 4, which is smaller than OFFSET₁ due, for example, to processing delay and other timing errors in switching node 412.

Egress node 414 includes a PBS MAC component 440 that has a data demultiplexer 442, a data burst re-assembler 444, a control burst processing component 446, and a data burst de-framer 448. Egress node 414 receives the optical control burst as indicated by an arrow 470 in FIG. 4. Burst de-framer 448 receives and de-frames the control burst via a physical O-E interface (not shown). In this embodiment, control burst processing component 446 processes the de-framed control burst to extract the pertinent control/address information.

After the control burst is received, egress node 414 receives the data burst(s) corresponding to the received control burst, as indicated by an arrow 472 in FIG. 4. In this example, egress node 414 receives the optical data burst after a delay of OFFSET₂, relative to the end of the control burst. In a manner similar to that described above for received control bursts, burst de-framer 448 receives and de-frames the data burst. Data burst re-assembler 444 then processes the de-framed data burst to extract the data (and to re-assemble the data if the data burst was a fragmented data burst). Data de-multiplexer 442 then appropriately de-multiplexes the extracted data for transmission to the appropriate destination (which can be a network other than the PBS network).

FIG. 5 illustrates a generic PBS framing format 500 for PBS optical bursts, according to one embodiment of the present invention. Generic PBS frame 500 includes a PBS generic burst header 502 and a PBS burst payload 504 (which can be either a control burst or a data burst). FIG. 5 also includes an expanded view of PBS generic burst header 502 and PBS burst payload 504.

PBS generic burst header 502 is common for all types of PBS bursts and includes a version number (VN) field 510, a payload type (PT) field 512, a control priority (CP) field 514, an in-band signaling (IB) field 516, a label present (LP) field 518, a header error correction (HEC) present (HP) field 519, a data encryption (DE) field 520, a burst length field 522, and a burst ID field 524. In some embodiments, PBS generic burst header also includes a reserved field 521 and a HEC field 526. Specific field sizes and definitions are described below for framing format having 32-bit words; however, in other embodiments, the sizes, order and definitions can be different.

In this embodiment, PBS generic burst header 502 is a 4-word header. The first header word includes VN field 510, PT field 512, CP field 514, IB field 516 and LP field 518. VN field 510 in this exemplary embodiment is a 4-bit field (e.g., bits 0-3) defining the version number of the PBS Framing format being used to frame the PBS burst. In this embodiment, VN field 510 is defined as the first 4-bits of the first word, but in other embodiments, it need not be limited to the 4-bits, or be in the first word.

PT field 512 is a 4-bit field (bits 4-7) that defines the payload type. Exemplary payload types are shown below.

CP field 514 is a 2-bit field (bits 8-9) that defines the burst's priority. For example, binary “00” may indicate a normal priority while binary “01” indicates a high priority.

IB field 516 is a one-bit field (bit 8) that indicates whether the PBS control burst is being signaled in-band or OOB. For example, binary “0” may indicate OOB signaling while binary “1” indicates in-band signaling. LP field 518 is a one-bit field (bit 11) used to indicate whether a label has been established for the lightpath carrying this header.

HP field 519 is a one-bit field (bit 12) used to indicate whether header error correction is being used in this control burst. For example, binary “1” may indicate header error correction is used, while binary “0” indicates it is not used.

Data Encryption (DE) field 520 is a one-bit field (bit 13) used to indicate whether subsequent data bursts (corresponding to a control burst for which DE field 520 is asserted) contains encrypted data. The remaining bits (bits 14-31) form reserved field 521, which is currently unused and reserved for future use.

The second word in PBS generic burst header 502 contains PBS burst length field 522, which is used to store a binary value equal to the length the number of bytes in PBS burst payload 504. In this embodiment, the PBS burst length field is 32-bits.

The third word in PBS generic burst header 502 contains PBS burst ID field 524, which is used to store an identification number for this burst. In this embodiment, PBS burst ID field 524 is 32-bits generated by the ingress node (e.g., ingress node 410 in FIG. 4).

The fourth word in PBS generic burst header 502 contains generic burst header HEC field 526, which is used to store an error correction word. In this embodiment, generic burst header HEC field 526 is 32-bits generated using any suitable known error correction technique. As in indicated in FIG. 5, generic burst header HEC field 526 is optional in that if error correction is not used, the field may be filled with all zeros. In other embodiments, generic burst header HEC field 526 is not included in PBS generic burst header 502.

PBS burst payload 504 is common for all types of PBS bursts and includes a PBS specific payload header field 532, a payload field 534, and a payload frame check sequence (FCS) field 536.

In this exemplary embodiment, PBS specific payload header 532 is the first part (i.e., one or more words) of PBS burst payload 504. Typically, specific payload header field 532 includes one or more fields for information related to a data burst, which can be either this burst itself or contained in another burst associated with this burst (i.e., when this burst is a control burst).

Payload data field 534 is the next portion of PBS burst payload 504. In some embodiments, control bursts have no payload data, so this field may be omitted or contain all zeros. For data bursts, payload data field 534 may be relatively large (e.g., containing multiple data packets or frames).

Payload FCS field 536 is the next portion of PBS burst payload. In this embodiment, payload FCS field 536 is a one-word field (i.e., 32-bits) used in error detection and/or correction. As in indicated in FIG. 5, payload FCS field 536 is optional in that if error detection/correction is not used, the field may be filled with all zeros. In other embodiments, payload FCS field 536 is not included in PBS burst payload 504.

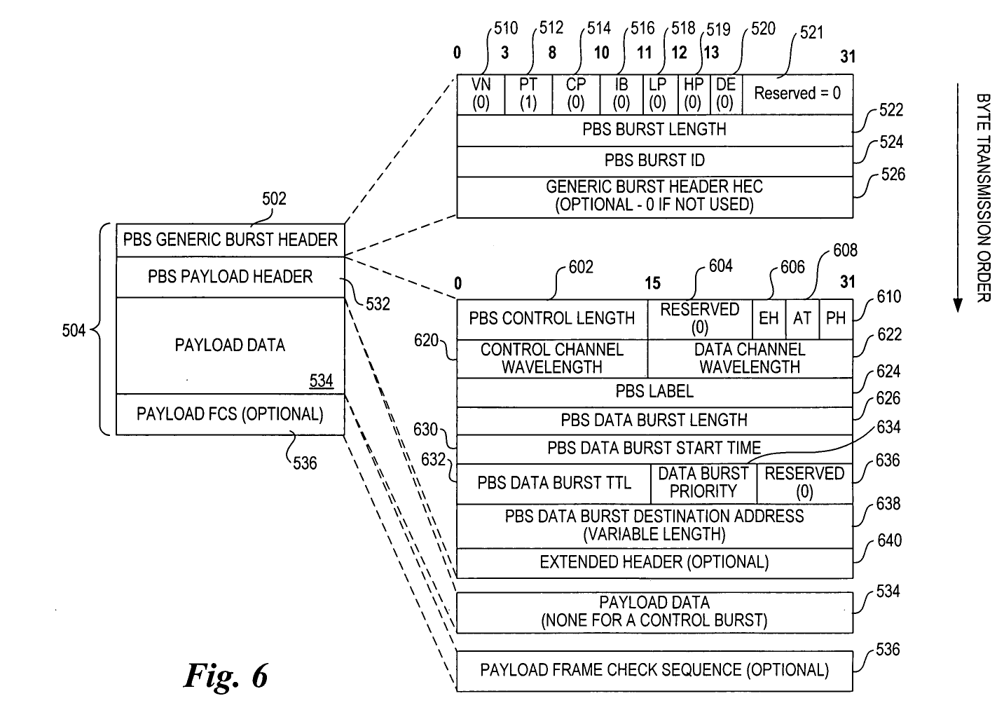

FIG. 6 illustrates a PBS optical control burst framing format 600, according to one embodiment of the present invention. To help improve clarity, FIG. 6 includes the expanded views of PBS generic burst header 502 and PBS burst payload 504 (previously described in conjunction with FIG. 5), with a further expansion of PBS payload header field 532 (described below) when part of a control burst. In this example, the PT field is set to “01” to indicate that the burst is a control burst. The CP field is set to “0” to indicate that the burst has normal priority. The IB field is set to “0” to indicate that the burst is using OOB signaling. The LP field is set to “0” to indicate that there is no label for this control burst.

In this exemplary embodiment of a PBS control burst, PBS payload header field 532 includes: a PBS control length field 602; an extended header (EH) field 606; an address type (AT) field 608; a payload FCS present (PH) field 610; a control channel wavelength field 620; a data channel wavelength field 622; a PBS label field 624; a PBS data burst length field 626; a PBS data burst start time field 630; a PBS data burst time-to-live (TTL) field 632; a data burst priority field 634; a PBS data burst destination address field 638; and an optional extended header field 640.

In this embodiment, the first word of PBS payload header 532 includes PBS control length field 602, which is used for storing the length of the control header in bytes. In this embodiment, PBS control length field 602 is a 16-bit field (bits 0-15) calculated by control burst builder 426 or control burst processor 432 (FIG. 4). In other embodiments, PBS control length field 602 need not be the first 16-bits, in the first word, or limited to 16-bits. A reserved field 604 (bits 16-27) is included in PBS payload header 532 in this embodiment. In other embodiments, these bits may be used for other field(s).

The first word of PBS payload header 532 also includes EH field 606, which is used in this embodiment to indicate whether an extended header is present in the burst. In this embodiment, EH field 606 is a 1-bit field (bit 28). In other embodiments, EH field 606 need not be bit 28, or in the first word.

The first word of PBS payload header 532 also includes AT field 608, which is used in this embodiment to indicate the address type of the associated PBS data burst's destination. For example, the address type may be an IP address (e.g., IPv4, IPv6), a network service access point (NSAP) address, an Ethernet address or other type of address. In one embodiment, AT field 608 is a 2-bit field (bits 29-30).

The first word of PBS payload header 532 also includes PH field 610, which is used to indicate whether a payload FCS is present in the burst. In this embodiment, PH field 610 is a 1-bit field (bit 31).

The second word of PBS payload header 532 includes control channel wavelength field 620, which is used to indicate a WDM wavelength in which the control burst is supposed to be modulated. In this embodiment, control channel wavelength field 620 is a 16-bit field (bits 0-15).

The second word of PBS payload header 532 also includes data channel wavelength field 622, which is used to indicate a WDM wavelength in which the data burst is to be modulated. In this embodiment, data channel wavelength field 622 is a 16-bit field (bits 16-31).

A third word of PBS payload header 532 includes PBS label field 624, which is used to store the label (if any) for the lightpath being used by the burst. In this embodiment, the label is a 32-bit word generated by a label management component.

A fourth word of PBS payload header 532 includes PBS data burst length field 626. In this embodiment, the PBS data burst length is a 32-bit word.

A fifth word of PBS payload header 532 includes PBS data burst start time field 630. In this embodiment, the PBS data burst start time is a 32-bit word, generated by burst scheduler 422 (FIG. 4).

A sixth word of PBS payload header 532 includes PBS data TTL field 632. In this embodiment, PBS data TTL field 632 is a 16-bit (bits 0-15) field, generated by ingress PBS MAC component 420 (FIG. 4). For example, in one embodiment, burst scheduler 422 (FIG. 4) of ingress PBS MAC component 420 can generate the TTL value.

The sixth word of PBS payload header 532 also includes data burst priority field 632. In this embodiment, data burst priority field 632 is an 8-bit field (bits 14-23), generated by ingress PBS MAC component 420 (FIG. 4). For example, in one embodiment, burst scheduler 422 (FIG. 4) of ingress PBS MAC component 420 can generate the data burst priority value. Further, in this embodiment, the sixth word of PBS payload header 532 includes a reserved field 636 (bits 24-31) which can be used in the future for other field(s).

A seventh word of PBS payload header 532 also includes PBS data burst destination address field 638. In this embodiment, PBS data burst destination address field 638 is variable length field, shown as a single 32-bit word for clarity. The actual length of the address may vary, depending on the address type as indicated in AT field 608.

An eight word of PBS payload header 532 can include an optional extended header field 640. This header can be used to hold other header data that may be used in the future. When this header is used, EH field 606 is set to 1. In this embodiment, payload data field 534 and payload FCS field 536 have been described above.

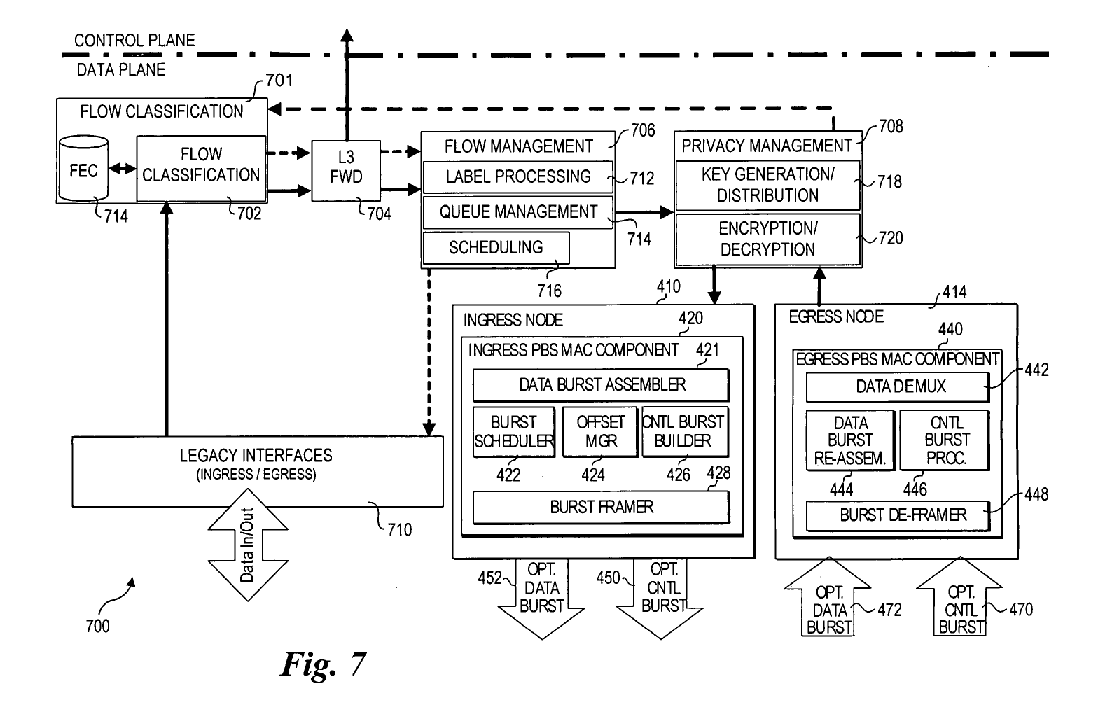

FIG. 7 shows an integrated data and control-plane PBS software architecture 700 with the key building blocks at ingress/egress nodes. Data plane components in architecture 700 includes a flow classification building block 701 including a flow classification block 702, an L3 (Layer 3, i.e. the Internet layer in the networking stack) forwarding block 704, a flow management building block 706, a privacy management building block 708, and legacy interfaces 710. The flow management building block 706 includes a label processing block 712, a queue management block 714, and a scheduling block 716. The privacy management building block 708 includes a key generation/distribution block 718, and an encryption/decryption block 720. In general, all or a portion of the key generation/distribution block 718, and an encryption/decryption block 720 may be embodied as one or more software modules, or may comprises hardware components that are programmed to perform corresponding operations. In addition, the data plane components include the ingress node 410 and egress node 414 components discussed above with reference to FIG. 4.

On the data path, packets from legacy interfaces 710, (i.e., IP packets or Ethernet frames) are classified by flow classification block 702 based on n-tuples classification into forward-equivalent classes (FECs) 714 at the ingress/egress node. Specifically, a PBS MAC layer at the ingress node typically performs data burst assembly and scheduling, control burst generation, and PBS logical framing, while de-framing, de-fragmentation and flow de-multiplexing are performed at the egress node. Once classified, data corresponding to a given FEC is forwarded to L3 forward block 704. If the flow is for this node IP address, i.e. this node L3 address, then the flow is given to this node for processing, i.e., it is given to this node control plane to be processed.

The next operations concern flow management. These are handled by label processing block 712 and queue management block 714. Timing of when portions of data destined for legacy network components are sent is determined by scheduling block 716.

In accordance with further aspects of the invention, techniques for securing transmitting data burst across PBS networks are now discussed. In general, after data received at an ingress node are classified and processed, they are encrypted within privacy management building block 708. The encryption decision may be based on user choice and/or management station policies. The data are then encrypted and forwarded to ingress PBS MAC component 420, where they are assembled into appropriate data burst that are scheduled for dispatch. Upon dispatch, the encrypted data based on the selected encryption method as described below (i.e., PKI) are sent to a destined egress node defined by a virtual lightpath comprising one or more hops. In response to receiving data burst, the egress node de-frames the burst and re-assembles the data. The data are then passed to a privacy management block 708 hosted by the egress node, whereupon the re-assembled data are decrypted. The data may then be sent in its decrypted form to an external (to the PBS network) network via legacy interfaces 710.

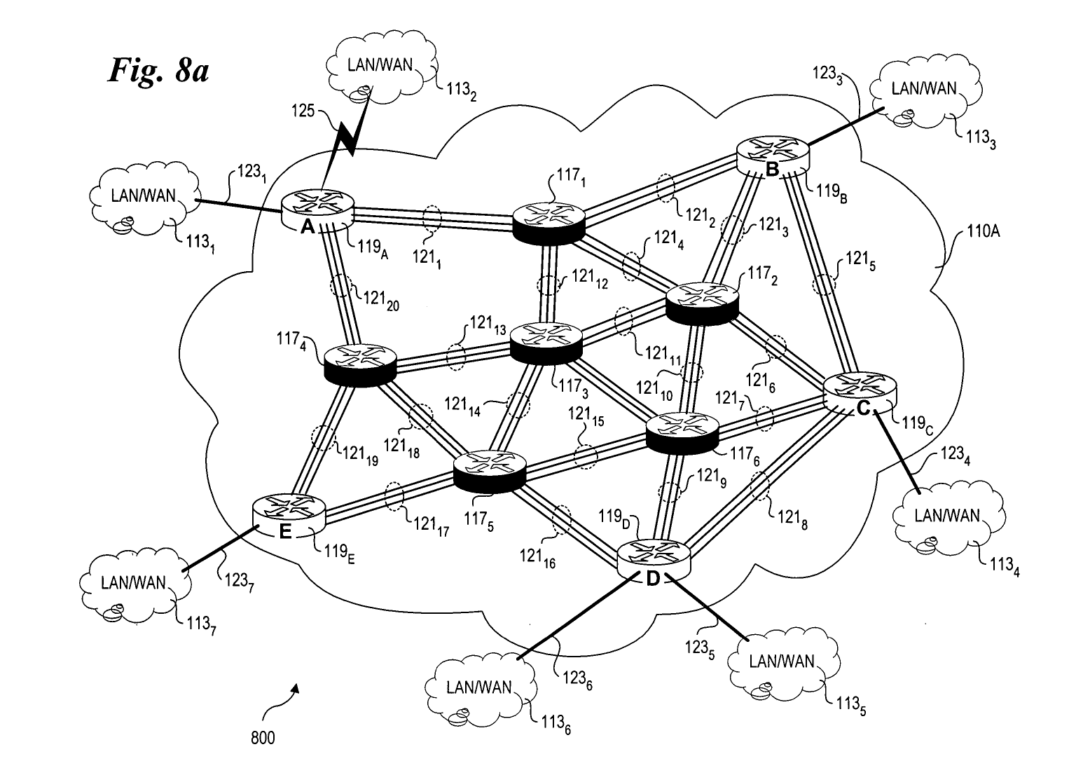

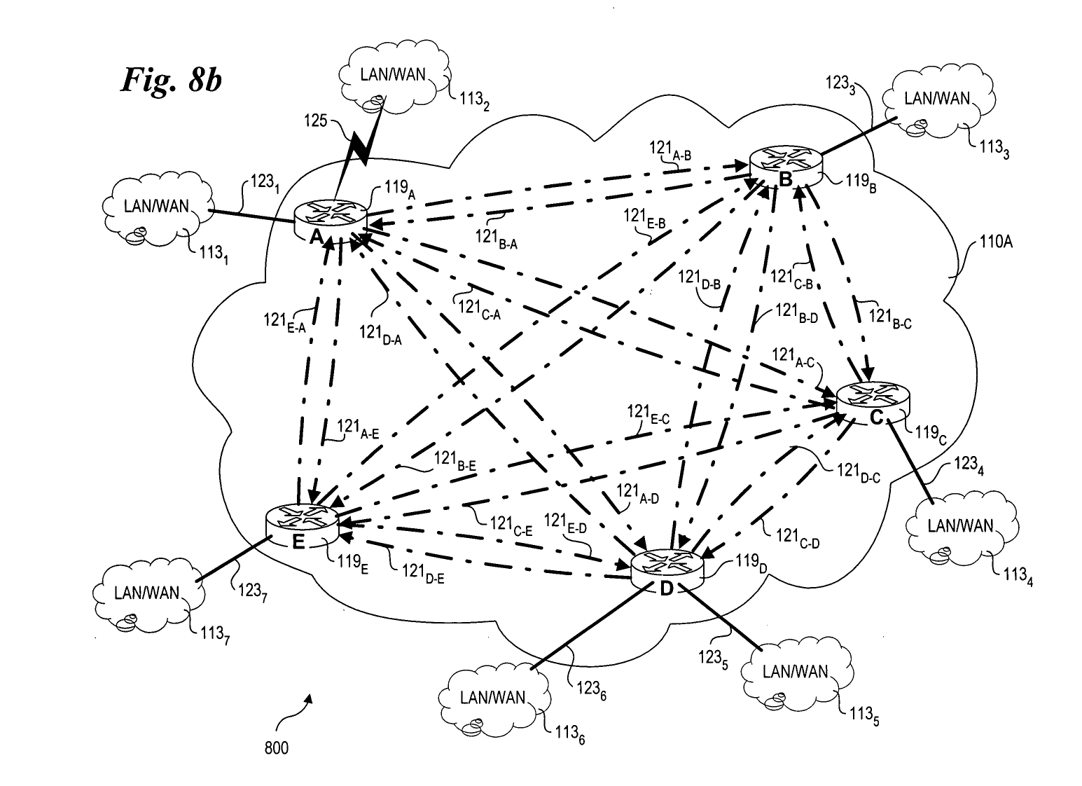

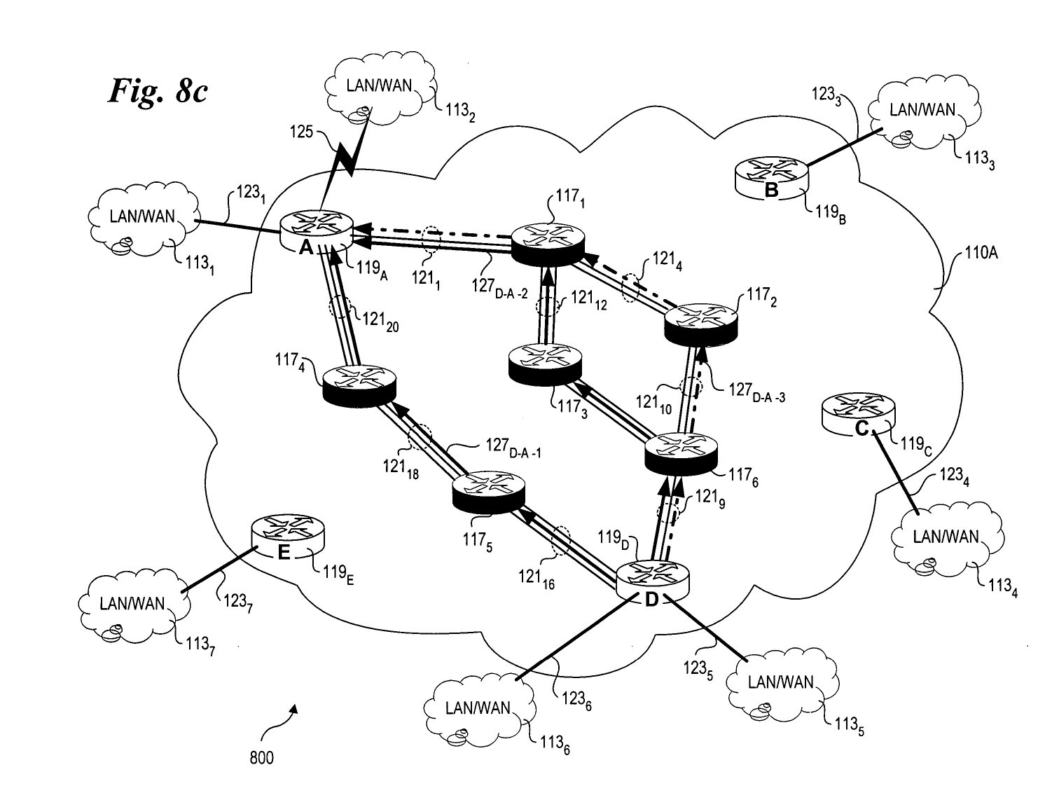

Various levels of details of an exemplary network infrastructure 800 used in conjunction with secure transmission embodiments described below is shown in FIGS. 8a-c. The network infrastructure is centered on a PBS network 110A. The PBS network includes multiple edge nodes 119_{A-E} (labeled A-E for clarity), which are generally interconnected via a plurality of switching nodes 117₁₋₆. Under the construct of PBS network 110 of FIG. 1, a given edge node 119 may function as an ingress node, and egress node, or both (most common). The switching nodes 117₁₋₆ function in the manner discussed above in conjunction with FIG. 1. The various edge nodes 119_{A-E} are connected to external networks 113₁₋₇.

The various edge and switching nodes in PBS network 110A are interconnected via fiber links 121₁₋₂₀. Each of these fiber links are depicted as three lines for illustrative purposes. The three lines represent multiple WDM channels that may shared a common fiber, wherein each of the WDM channels corresponds to a respective wavelength. The number of wavelengths per fiber link will generally be a function of the channel grid spacing and the number of channels selected to be employed. In addition, there may be more than one fiber link between any pair of nodes (not shown).

Each of external networks 113₁₋₇ is connected to an edge node 119_{A-E} via a respective communication link. These communications links may include an optical or wired link (as shown by physical links 123₁ and 123₃₋₇, or a wireless link, as shown by a wireless link 125. Generally, a given external network 113 may comprise a LAN, WAN, MAN or storage area network (SAN).

From the perspective of the embodiments described below, the particular routes that are employed for given data burst transmissions are substantially irrelevant. From a security perspective, data to be sent as one or more data bursts are encrypted and sent from a first (source) edge node, traverse a virtual lightpath between the first edge node and a second (destination) edge node, whereupon the encrypted data are decrypted. The virtual lightpath comprises a concatenation of hops between the source and destination edge nodes and any switching nodes in-between that are defined by the route. However, from the security perspective, the particular route is generally not considered. Thus, in the following embodiments, all that needs to be known for a given transmission are the source and destination edge nodes.

For clarity, FIG. 8b shows network infrastructure 110A from a security perspective. In this case, the edge nodes 119_{A-E} are connected to each other by various virtual lightpaths 107_{S-D}, wherein subscript S represents a source edge node and subscript D represents a destination edge node. For example, a virtual lightpath from edge node A to edge node B is denoted 121_{A-B}, and so on.

As discussed above, a virtual lightpath generally does not correspond to a specific physical link between source and destination edge node, except in cases in which such links exist, such as fiber link 121₅ between edge nodes C and B in FIG. 8a. For example, FIG. 8c shows three virtual lightpaths between edge nodes D (the source node) and A (the destination node), labeled 127_{D-A-1}, 127_{D-A-2}, and 127_{D-A-3}. As illustrated by each of these virtual lightpaths, a lightpath typically comprises a concatenation of hops between nodes, wherein each hop is defined by a respective lightpath segment. In one embodiment, the entire virtual lightpath employs a common wavelength, as depicted by virtual lightpath 127_{D-A-3}. In other embodiments, the wavelength used for each lightpath segment may vary along the entire lightpath, as illustrated by virtual lightpaths 127_{D-A-1} and 127_{D-A-2}. In some instances, the virtual lightpath will comprise a fiber segment connecting source and destination edge nodes to one another.

In accordance with aspects of the embodiments disclosed herein, security measures are provided to ensure data transmitted over optical switched networks, such as PBS networks, may not be intercepted or otherwise stolen. In general, the embodiments described below use encryption and decryption schemes to provide data security. In one embodiment, encryption and decryption operations are performed in accordance with public key infrastructure (PKI) principles and rules. The globally-recognized method for secure transactions is to use digital certificates to enable the encryption and digital signing of the exchanged data. The term “public key infrastructure” is used to describe the processes, policies, and standards that govern the issuance, maintenance, and revocation of the certificates, public, and private keys that the encryption and signing operations require.

Public key cryptography allows users of an insecure network, like the Internet, to exchange data with confidence that it will be neither modified nor inappropriately accessed. This is accomplished through a transformation of the data according to an algorithm parameterized by a pair of numbers—the so-called public and private keys. Each participant in the exchange has such a pair of keys. They make the public key freely available to anyone wishing to communicate with them, and they keep the other key private and protected. Although the keys are mathematically related, if the cryptosystem has been designed and implemented securely, it is computationally infeasible to derive the private key from knowledge of the public key.

The nature of the relation between the public and private keys is such that a cryptographic transformation encoded with one key can only be reversed with the other. This defining feature of public key encryption technology enables confidentiality because a message encrypted with the public key of a specific recipient can only be decrypted by the holder of the matching private key (i.e., the recipient, if they have properly protected access to the private key). Even if intercepted by someone else, without the appropriate private key, this third party will be unable to decrypt the message.

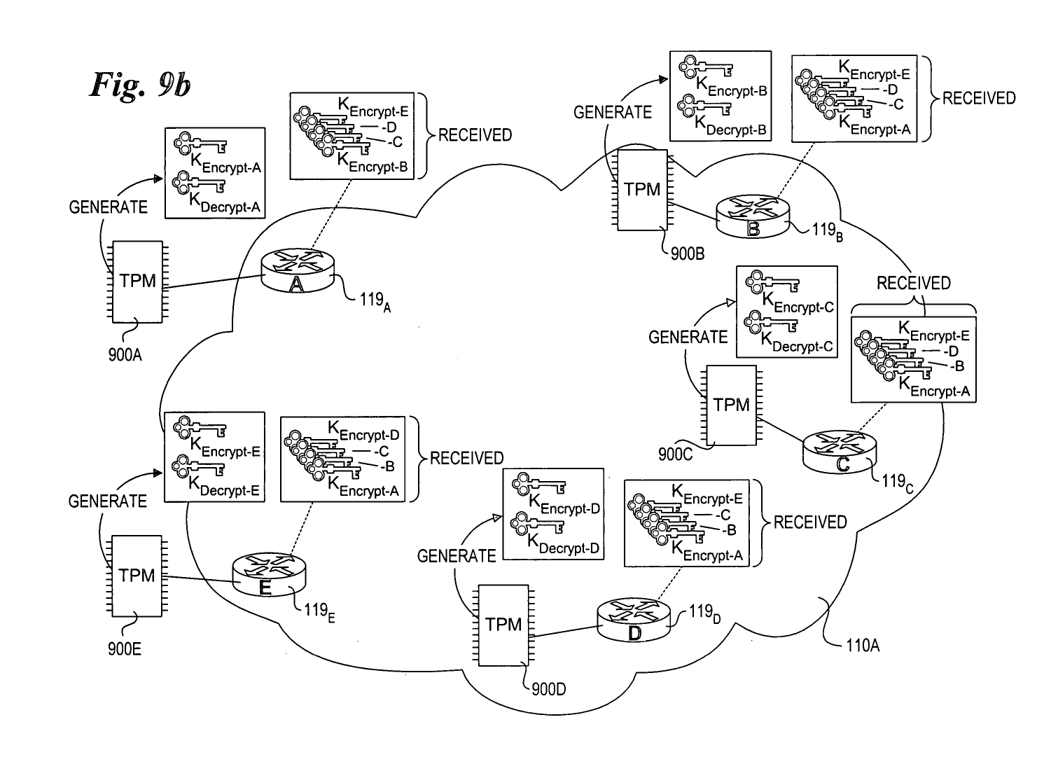

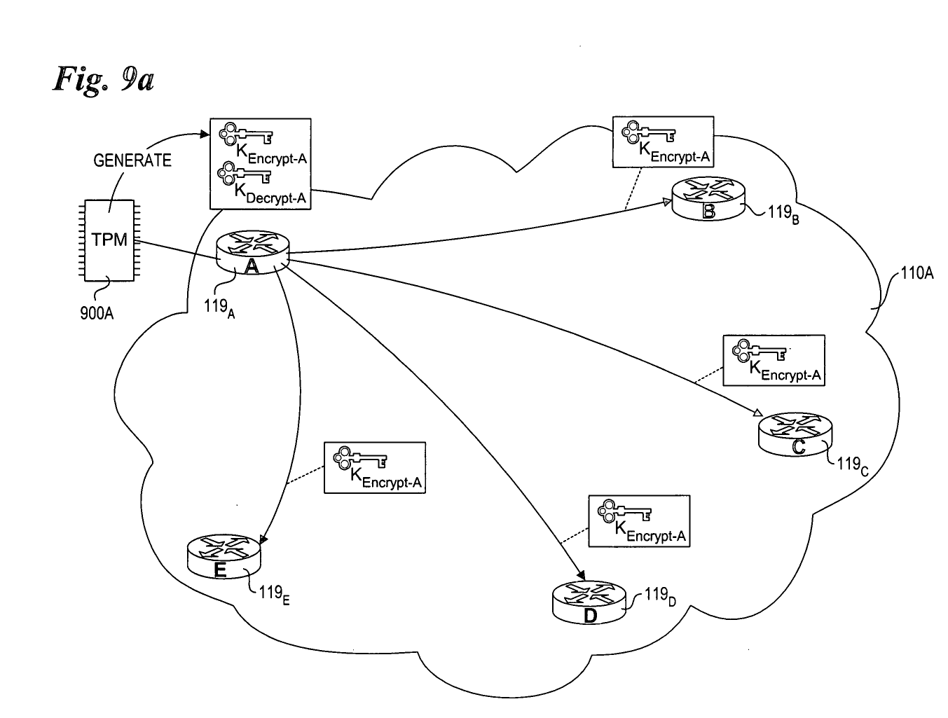

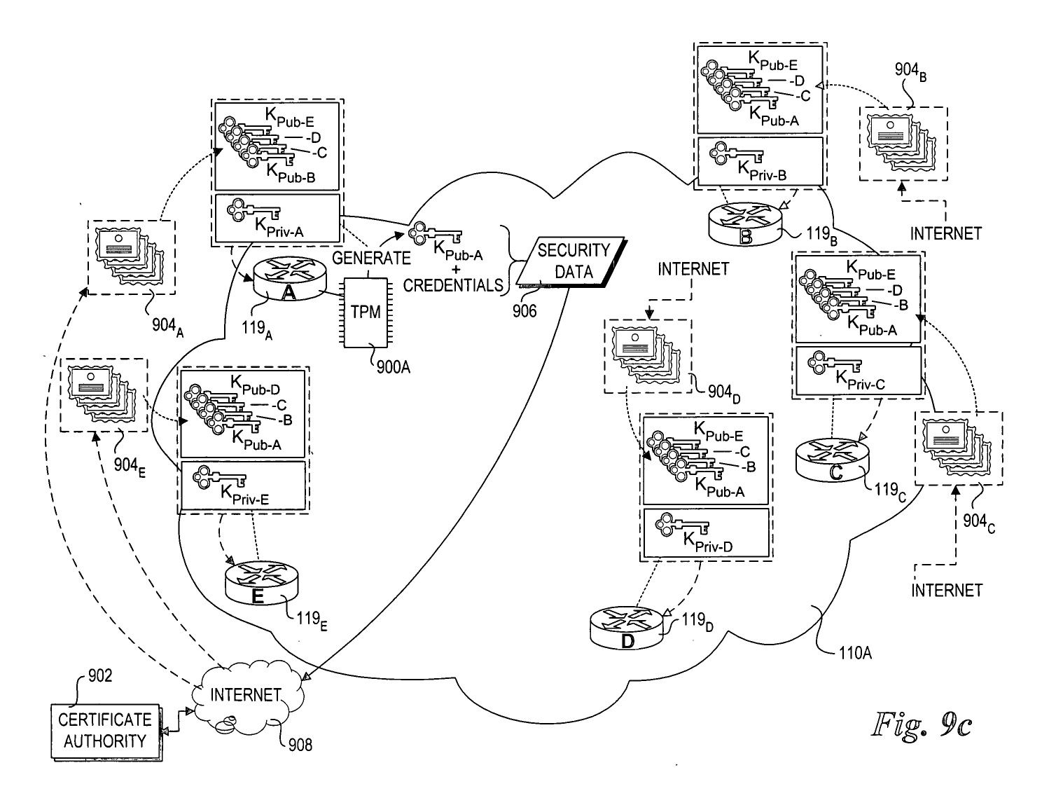

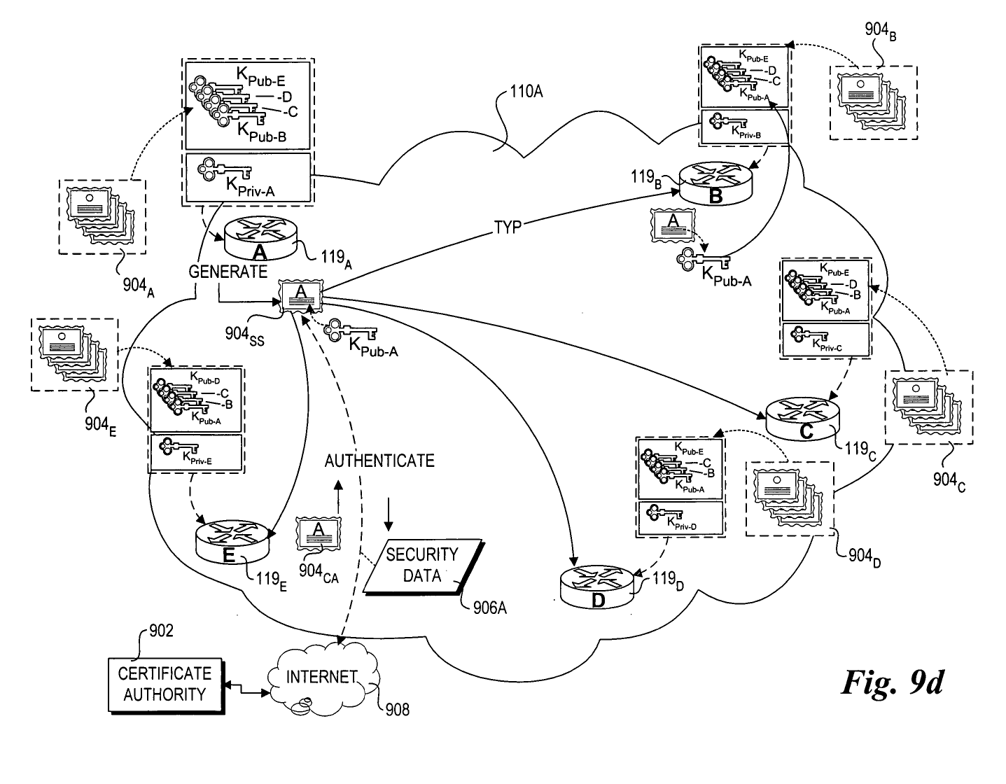

In order to employ encryption-based security measures, there needs to be a mechanism for distributing keys. FIGS. 9a-b, FIG. 9c, and FIG. 9d show exemplary key distribution schemes in accordance with respective embodiments. The schemes of FIGS. 9a and 9b are analogous to PKI schemes in their use of asymmetric key pairs, but they do not employ any public infrastructure. The schemes of FIGS. 9c and 9d are implemented via PKI facilities.

In accordance with further aspects of the embodiments, a Trusted Computing Group (TCG) (http://www.trustedcomputinggroup.org) security scheme is implemented to store and retrieve security-related data. In the embodiments of FIGS. 9a-d, a TCG token comprising a trusted platform module (TPM) is employed. Generally, TPM functionality may be embodied as a hardware device (most common) or via software. For example, integrated circuits have been recently introduced to support TPM functionality, such as National Semiconductor's LPC-based TCG-compliant security controller. Such an integrated circuit is depicted as TPM 900n (where n represents letters from A-E) in FIGS. 9a-d.

TCG is an industry consortium concerned with platform and network security. The TCG main specification (Version 1.2, October, 2003—hereinafter referred to as the “version 1.2 specification”) is a platform-independent industry specification that covers trust in computing platforms in general. The TCG main specification defines a trusted platform subsystem that employs cryptographic methods when establishing trust. The trusted platform may be embodied as a device or devices, or may be integrated into some existing platform component or components. The trusted platform enables an authentication agent to determine the state of a platform environment and seal data particular to that platform environment. Subsequently, authentication data (e.g., integrity metrics) stored in a TPM may be returned in response to an authentication challenge to authenticate the platform.

Reference is now made to the key-distribution schemes of FIGS. 9a and 9b, which illustrate a first key-generation and distribution embodiment employing trusted platform modules. Under this scheme, a pair of asymmetric keys labeled K_{Encrypt-n} and K_{Decrypt-n} are generated by a TPM 900n located at each node n, where “n” denotes one of PBS edge nodes A, B, C, D, and E. For example, in FIG. 9a, PBS edge node A employs a TPM 900A to generate a pair of asymmetric keys K_{Encrypt-A} and K_{Decrypt-A}. These encryption and decryption keys are analogous to the public and private key pairs discussed below for the PKI infrastructure. The same public encryption key, K_{Encrypt-A}, is sent to each of PBS edge nodes B, C, D, and E. Subsequently, these encryption keys may be used to encrypt data that is sent to PBS edge node A, which holds the “private” or “secret” decryption key, K_{Decrypt-A}.

Since the encryption key K_{Decrypt-A} is required to decrypt any data that is encrypted with encryption key K_{Encrypt-A}, the only entity that may decrypt such data is PBS edge node A. This means that if a message or data stream encrypted with K_{Encrypt-A} is somehow intercepted, the message or data stream will not be able to be decrypted (within reasonable mathematical limitations which are a function of the key length). Furthermore, if the encrypted message or data stream is inadvertently received by an improper destination edge node, that edge node will not be able to decrypt the message or data stream.

There are several mechanisms that may be employed for sending keys between PBS edge nodes. For example, a PBS network will generally include facilities for managing the various edge and switching nodes. These facilities may typically include an “external” link” such as an Ethernet link, which connects a central administrator server (not shown) to each of the PBS network nodes, enabling them to network via a conventional network. This enables a network administrator to configure and maintain the various network nodes without consuming in-band network resources (i.e., the fiber links used for sending high-speed payload traffic). Optionally, an out-of-band (OOB) channel that employs the PBS network infrastructure may be employed for similar purposes. For example, the OOB channel may use a different wavelength than the in-band channels. Under yet another scheme, security data (e.g., keys) may be transferred between edge nodes using a control burst, as described below.

Under the key generation and transfer scheme of FIGS. 9a and 9b, each of PBS edge nodes A-E generates a respective set of encryption and decryption keys K_{Encrypt-n} and K_{Decrypt-n}, with its TPM 900n and sends its “public” encryption key K_{Encrypt-n} to the other nodes, while protecting its “secret” or “private” decryption key K_{Encrypt-n}. The result of these operations (i.e., after all keys have been transferred) is shown in FIG. 9b.

The schemes of FIGS. 9c and 9d are roughly analogous to the scheme of FIGS. 9a and 9b, except this time public key infrastructure facilities are used. As before, each PBS edge node n generates an asymmetric key pair—this time, however, the encryption key is referred to as a public key (K_{Pub-n}), while the decryption key is referred to as a private key (K_{Priv-n}). Rather than directly sending the public keys K_{Pub-n} to recipient PBS edge nodes, these keys are distributed via digital certificates 904A-E.

In their simplest form, digital certificates, which are also referred to as “authentication certificates,” contain a public key and a name. As commonly used, a digital certificate also contains an expiration date, information identifying the certifying authority that issued the certificate (e.g., certificate authority 902), a unique identifier (e.g., serial number), and perhaps other information. Importantly, a digital certificate also contains a digital signature of the certificate issuer. The most widely accepted format for certificates is defined by ITU (International Telecommunications Union)-T X.509 international standard. Accordingly, in one embodiment digital certificates 904A-E comprise ITU-T X.509 certificates.

In the embodiment of FIG. 9c, the certificate issuer is certificate authority 902. Each edge node generates security data 906 including a public key K_{Pub-n} and credential data (e.g., attestation information, etc.). The security data 906 is then sent to certificate authority 902 via a public network, such as Internet 908.

Generally a certificate authority (CA) is a trusted third party that provides certificate authentication services. The CA does not generate public keys, but rather provides authentication information relating to public keys via issuance of certificates containing those keys, along with other attestation data. Another function performed by a CA, or another trusted third party, is certificate validity. In general, certificates issued by CA's carry an expiration date. This is to ensure that a given public key is in the public domain for a limited duration. Accordingly, a first validity check is to check the expiration date on the certificate to verify it has not expired. At the same time, certificates may be revoked for one or more reasons. Since certificates may be widely distributed, there is no feasible mechanism for directly apprizing a certificate owner that a certificate has been revoked. One way this problem is addressed is by providing an Internet site (e.g., Verisign) that hosts a certification revocation list. This list can be checked by a client to verify a certificate has not been revoked. In one embodiment, this may be performed any of edge nodes A-E on a periodic basis.

Although FIG. 9c depicts digital certificates 904A-E as being provided to edge nodes A-E via Internet 908, this is not meant to be limiting. In other embodiments, the digital certificates may be returned to a central administrator server (not shown) and then individually distributed to the appropriate edge nodes. In yet another embodiment, the central administrator extracts public key and possibly other information (e.g., a digital signature) and provides this information to the appropriate edge nodes. As before, the key distribution scheme may employ an external link or an OOB channel. The other edge nodes would perform similar operations.

Once the keys are distributed, the operation of the embodiment of FIG. 9c is analogous to that discussed above in conjunction with FIGS. 9a-b. More specifically, a public key K_{Pub-n} is selected based on the destination node, and data are encrypted using that public key. At the destination end, the corresponding private key (K_{Priv-n}) held by the destination edge node is used to decrypt the encrypted data.

Yet another key distribution scheme is shown in FIG. 9d. It shall be recognized that the keys sets ultimately provided to each of edge nodes A-E are the same in each of embodiments 9c and 9d. However, under the embodiment of FIG. 9d, each edge node generates a self-signed X.509 digital certificate 904_{SS} or obtains an authenticated X.509 digital certificate 904_{CA} by first passing corresponding security data 906A to certificate authority 902 and receiving the authenticated X.509 certificate. (For clarity, only self-signed X.509 digital certificates 904_{SS} authenticated X.509 digital certificate 904_{CA} for edge node A are shown in FIG. 9d; it will be understood that they other edge nodes B-E generate or receive similar digital certificates.) As before, the certificate includes a public key K_{Pub-n} corresponding to and asymmetric with the private key the K_{Priv-n} held by the edge node that generated the key pair. Similar activities are performed for each of the other edge nodes, such that each edge nodes ends up holding its own private key and a set of public keys respectively corresponding to each of the other edge nodes.

In one embodiment, TPMs are employed to provide another layer of security. Under this scheme, a private encryption key is “sealed” against a TPM. The sealing mechanism requires an identical trusted platform configuration (i.e., selected trusted platform firmware and/or software) to exist when data is “unsealed” as when the same data was sealed. If the trusted platform configuration differs, the data can not be unsealed (i.e., cannot be accessed). One advantage of this security scheme is that a rogue or otherwise unauthorized entity cannot gain access to either a particular private key or data sent to an authorized entity holding the key.

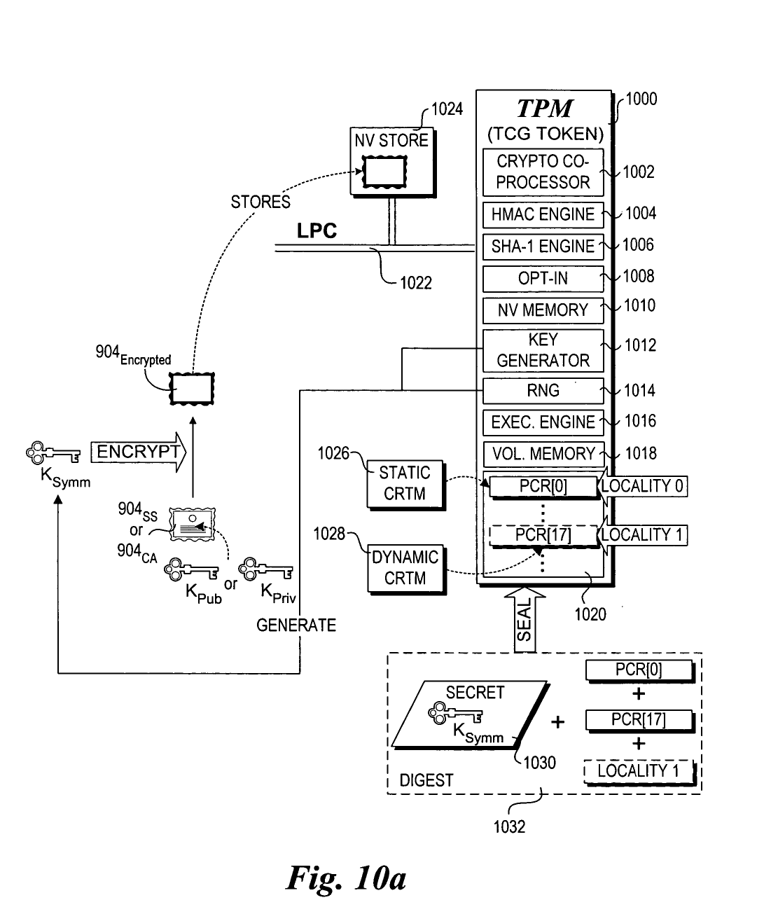

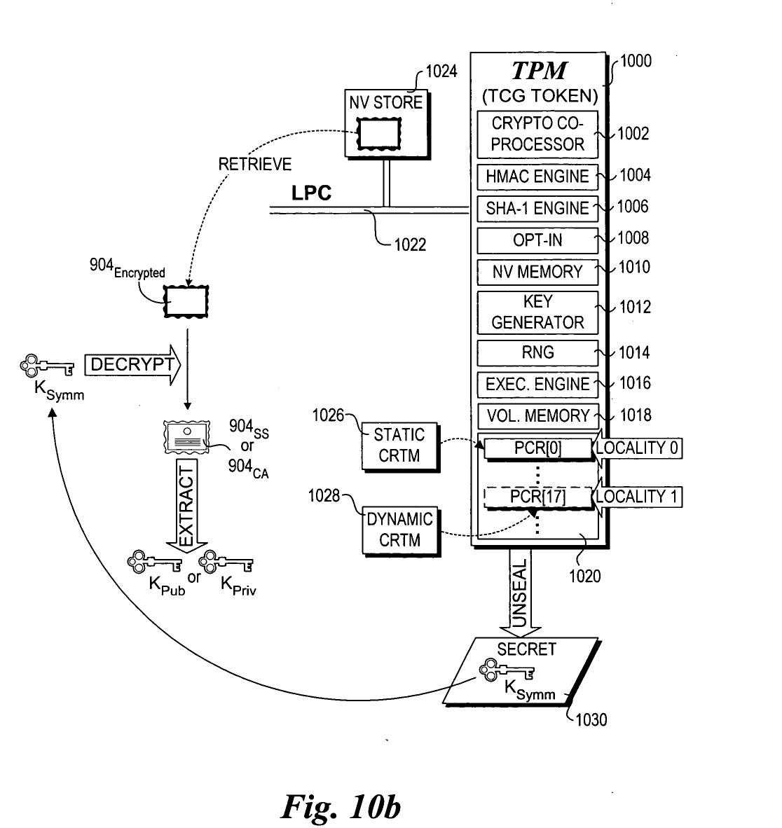

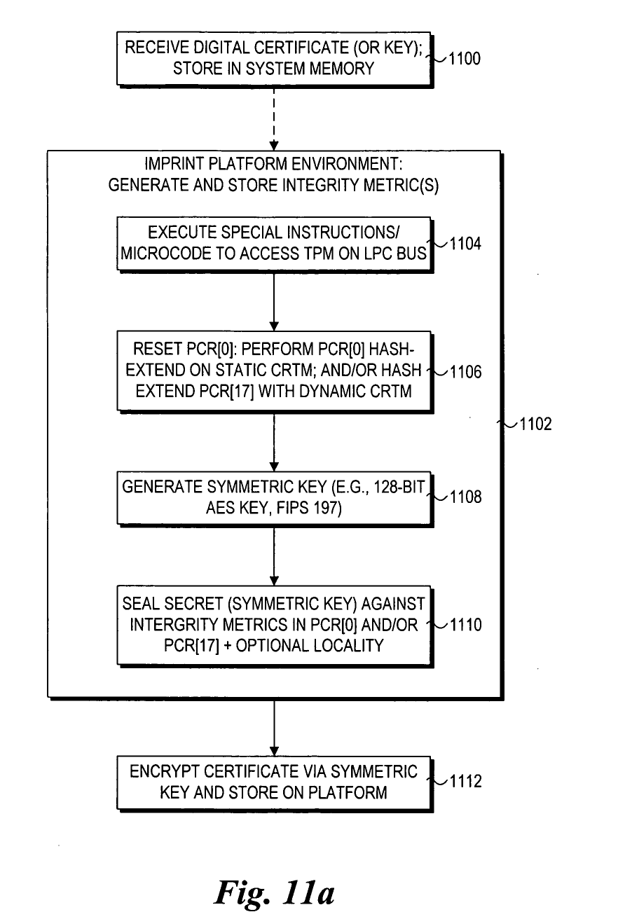

In order to better understand how this security mechanism works, attention is drawn to FIG. 10, which shows details of a TPM 1000 and associated circuitry. TPM 1000 provides several functions relating to security. These include an cryptographic co-processor 1002, an HMAC (Hashing for Message AuthentiCation) engine 1004, and SHA-1 (security hash algorithm—1) engine 1006, an Opt-In component 1008, non-volatile (NV) memory 1010, a key generator 1012, a random number generator (RNG) 1014, an execution engine 1016, volatile memory 1018, and Platform Configuration Registers (PCRs) 1020. Also provided in one TPM embodiment but not shown are an input/output component and a power detection component. FIG. 10 also shows a low pin count (LPC) bus 1022 and a non-volatile store 1024. In one embodiment, LPC bus 1022 is configured per Intel LPC Interface Specification Revision 1.0, Sep. 29, 1997.

In general, security keys may be generated by key generator 1012 or random number generator 1014. HMAC engine 1004 and SHA-1 engine 1006 are used to perform hashing operations in accordance with the well-known HMAC and SHA-1 hashing algorithms. If desired, a TPM may perform encryption and decryption operations via cryptographic co-processor 1002. More commonly, encryption and decryption operations will be performed by a dedicated cryptographic engine or cryptographic software running on a general-purpose processor. However, for key sizes that are larger, encryption and decryption operations performed using keys of anything (random keys?) other than smaller sizes (smaller than what?) will observe better performance if processed on a dedicated or general-purpose processor.

A TPM uses “integrity metrics” to ascertain platform configuration. A “trusted measurement root” in the TPM measures certain platform characteristics, logs-in the measurement data, and stores the final result in a TPM (which contains the root of trust for storing and reporting integrity metrics). When an integrity challenge is received, the trusted platform agent gathers the following information: the final results from the TPM, the log of the measurement data from the trusted platform measurement store, and TCG validation data that states the values that the measurements should produce in a platform configured in accordance with the configuration that existed at the time the integrity measurements were sealed. The operations of making an identity and enabling key-pair generation enables TPM functionality to be employed for authentication purposes to support secure network data transfers.

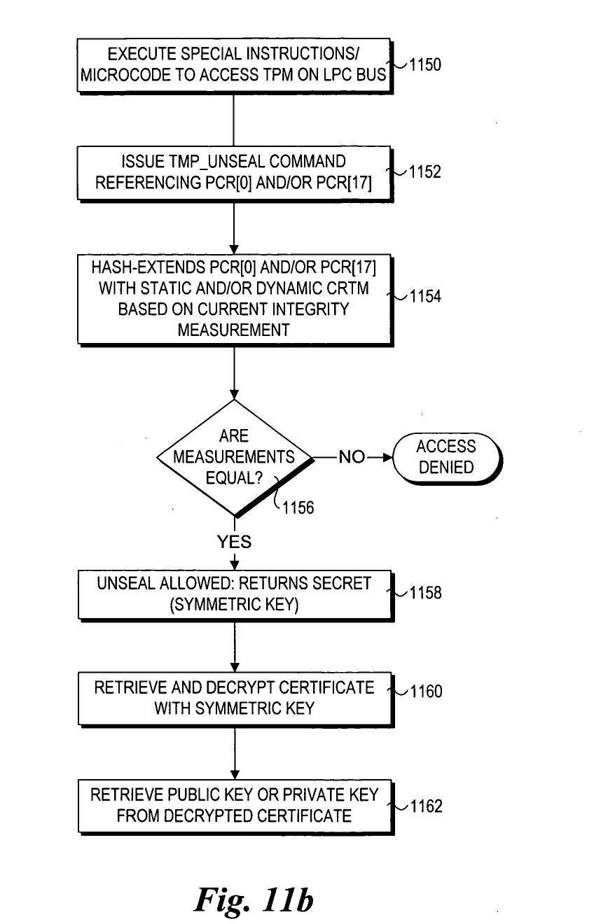

In accordance with one embodiment, security data (e.g., security keys or digital certificates) are sealed to a TPM by “imprinting” the platform environment corresponding to a PBS edge node. An exemplary process for sealing a digital certificate or security key against a TPM using an imprinted platform environment is shown in FIG. 11a. Prior to imprinting the platform environment it is presumed that a given PBS edge node (A-E) has received a digital certificate containing a private or public key, and that the digital certificate is stored in system memory, as depicted in a block 1100. Alternatively, an individual (i.e., not contained in a digital certificate) private or public key may sealed directly against the TPM using a scheme analogous to that described below.

Imprinting the platform environment is performed in a block 1102. In one embodiment, the platform is configured such that special instructions or microcode are required to access certain devices coupled to LPC bus 1022 via special bus cycle timing. These devices include TPM 1000 and NV storage device 1024. This provides an additional level of security between data stored in TPM 1000 and attacks on the platform. This operation is shown in a block 1104.

A second level of security is provided by storing integrity metric data in platform configuration registers 1020. PCR's 1020 are employed for securely storing data in a manner where certain authentication information must be provided to TPM 1000 in order to access data stored against the TPM that references a particular PCR.

A PCR is a 160-bit storage location for discrete integrity measurements. All PCR registers are shielded-locations and are inside of the TPM. The decision of whether a PCR contains a standard measurement or if the PCR is available for general use is deferred to the platform specific specification.

A large number of integrity metrics may be measured in a platform, and a particular integrity metric may change with time and a new value may need to be stored. It is difficult to authenticate the source of measurement of integrity metrics, and as a result a new value of the integrity metric cannot be permitted to simply overwrite an existing value. (A rogue entity could erase an existing value that indicates subversion and replace it with a benign value.) Thus, if values of integrity metrics are individually stored, and updates of integrity metrics must be individually stored, it is difficult to place an upper bound on the size of memory that is required to store integrity metrics.

Each PCR is designed to hold a large number of measurements in its register. It does this by using a cryptographic hash and hashing all updates to a PCR. The pseudo code for this is:
PCRᵢ New=HASH (PCRᵢ Old value∥value to add)
   wherein the “∥” symbol represents concatenation. Updates to a PCR register are sometimes referred to as “extending” the PCR, while the data measured to the PCR is sometimes called the “extend”.

In one embodiment, PCR0 provides capability of being reset. Accordingly, a hash-extend operation may be performed in a manner that produces PCR0 values that are independent of previously stored register values. This is advantageous with respect to being able to store integrity metrics corresponding to a given platform environment, and then subsequently compare integrity metrics corresponding to a current platform environment with the given platform environment.

A platform environment may correspond to a platform's firmware or software configuration, or a combination of the two. More specifically, an integrity metric corresponding to a platform environment may reflect a single environment component (i.e., firmware/software component), or a combination of components used to form an environment that exists at the time the integrity metric is measured. A core root of trust measurement (CRTM) based on a platform's firmware is referred to as a static CRTM 1026. A core root of trust measurement based on a platform's software is referred to as a dynamic CRTM 1028.

In one embodiment, the operations of block 1106 pertain to use of a static CRTM. In one embodiment, a static CRTM is created via a measurement of the platform's base firmware. The base firmware is a portion of firmware provided by the platform that cannot be partially replaced. The CRTM should be an immutable portion of the platform's initialization code that executes upon any platform reset. The trust in the platform is based on the CRTM. The trust in all measurements is based on the integrity of this component. Thus, the static CRTM is derived from a measurement of “static” firmware.

In one embodiment, a static CRTM is assigned to a platform configuration register 1020 referred to a PCR[0]. To store the static CRTM, PCR[0] is reset, and a hash-extend operation is performed on this PCR using an integrity measurement of the base firmware as the extend. In this context, the hash-extend operates on a reset register value (i.e., 0), and so the hash-extend operation simply reflects a hash of the base firmware.

In another embodiment, a dynamic CRTM is used as the platform CRTM. In one embodiment, integrity measurements corresponding to a dynamic CRTM are stored in a PCR registered PCR17. A dynamic CRTM is generated using a hash-extend operation in a similar manner to the foregoing static CRTM, except in this instance a trusted portion of system software (e.g., the OS kernel) is measured. In yet another embodiment, both a static CRTM and dynamic CRTM is measured and stored in respective PCR registers PCR[0] and PCR[17].

Following the generation of a static or dynamic CRTM, the next operation is performed in a block 1108, wherein a symmetric key (K_{Symm}) is generated using key generator 1012 or random number generator 1014. In one embodiment, K_{Symm} comprises a 128-bit AES (advanced encryption standard) key compliant with the Federal Information Processing Standard (FIPS) 197 standard.

In a block 1110, authentication credentials are sealed such that they may not be accessed by outside agencies. In one embodiment, this is performed by sealing K_{Symm} against the integrity metric stored in either PCR[0] or PCR[17]. In essence, what this does is require the same integrity metric to exist in PCR[0] or PCR[17] (as applicable) before the sealed value (K_{Symm}) may be unsealed, as described below.

Sealing operation is performed via the TPM_Seal command. The SEAL operation allows software to explicitly state a future “trusted” configuration that the platform must be in for the secret data (stored via the TPM_Seal command) to be revealed. The SEAL operation also implicitly includes the relevant platform configuration (PCR-values) when the SEAL operation was performed. The SEAL operation uses the tmpProof value to BIND a BLOB (Binary Large Object) to an individual TPM. The BLOB is also referred to as a “digest.” To retrieve the secret, and UNSEAL operation is performed. If the UNSEAL operation succeeds, proof of the platform configuration that was in effect when the SEAL operation was performed is returned to the caller, as well as the secret data. In one embodiment, a PCR provides a means for storing indicia identifying a processor locality at the time the secret is sealed; thus, the same locality is required to unseal the secret. For example, environments under firmware, software (i.e., OS) and processor control have different levels of locality.

In response to the TPM_Seal command, external data (the secret) is concatenated with a value of an integrity metric sequence and encrypted under a parent key. The TPM_Unseal command may be subsequently used to decrypt the BLOB using the parent key and export the plaintext data if the current integrity metric sequence inside the referenced TPM PCRs matches the value of integrity metric sequence inside the BLOB. The integrity metric in the current example is the value in PCR[0], PCR[17], or the combination of the two PCRs. In one embodiment, PCR[0] may be accessed via any locality. In one embodiment, a locality of 1 or greater is required to access PCR[17], such that this locality value is inherently stored in PCR17.

Details of an exemplary SEAL operation are shown in FIG. 10a. As depicted, the secret (data) 1030 comprises key K_{Symm}. In one embodiment, secret 1030 is concatenated with the value in PCR[0] to form a digest 1032. In another embodiment, secret 1030 is concatenated with the values in PCR[0] and PCR[17] to form digest 1032. Optionally, the locality may also be concatenated in forming the digest. The digest 1032 is then sealed to TPM 1000 using the TMP_Seal command (referencing the particular digest components). This completes the operation of imprinting the platform environment.

The last operation shown in FIG. 11a is depicted by a block 1112, wherein an authentication certificate 904SS or 904CA (or individual public or private key) is encrypted via K_{Symm} and stored as an encrypted certificate 904_{Encrypted} in a storage device that is accessible to the platform. For example, the encrypted certificate could be stored in NV store 1024. The encrypted certificate may also be stored elsewhere, such as in a protected area of a disk drive (not shown) or in NV memory 1010 of TPM 1000.

As discussed above, the corollary of sealing is unsealing the sealed data. With reference to the flowchart of FIG. 11b and the schematic diagram of FIG. 10b, an exemplary unsealing operation corresponding to the foregoing seal operation begins in a block 1150, where special instructions and/or microcode are used to access TPM 1000 on LPC bus 1022.

Next, in a block 1152, the TMP_Unseal command is issued, reference any applicable PCRs that where referenced in the corollary SEAL operations. In this example, the TMP_Unseal command will reference PCR[0] and/or PCR[17] in its list of arguments (depending on the combination of integrity metrics used above). This invokes the operations depicted in a block 1154, wherein hash extend operations are performed on PCR[0] and/or PCR[17] using current integrity metrics corresponding to current static CRTM and/or dynamic CRTM measurements, as applicable. If the integrity metrics have not changed, the corresponding extended hash values will remain the same. In contrast, if the integrity metrics have changed, so will the extended hash values.

The logical result of the foregoing is depicted in a decision block 1156. Per the TPM design, if the current integrity metrics do not match the corresponding integrity metrics that existed at the time the corollary SEAL operations was performed, access to the secret data (in the sealed digest) is denied. If the integrity metrics match, access is allowed, as depicted by the logic flow to a block 1158. In this block the secret (i.e., K_{Symm}) is returned, along with information indicating the integrity metrics have not changed. The secret is then extracted.

In a block 1160, the previously-encrypted certificate (or individual key) is retrieved from its storage located and decrypted with K_{Symm} yielding the original certificate (or the original individual key). If a certificate was used, the public or private key contained therein is retrieved in a block 1162, making it available for encryption or decryption operations, as applicable.

The foregoing scheme provides several levels of security. First of all, the private or public key (or certificate containing the same) is stored in an encrypted manner, such that if it (the encrypted data) were to be stolen, the key could not be accessed without having the key used for the encryption (K_{Symm} in the foregoing example). Meanwhile, K_{Symm} cannot be accessed by an unauthorized agent. Generally, the only way to access TPM 1000, other than through an authorized agent (e.g., base firmware or OS kernel), is to introduce a rogue firmware or software component. The existence of this rogue component would change the corresponding integrity metric, resulting in a hash-extend operation producing a different value than the hash result from the measurement of the trusted OS or firmware components (used for the static and/or dynamic CRTMs). Thus, the rogue component could not be used to access the TPM. Additionally, for implementations in which locality is used, only agents operating in the proper locality are allowed access to PCR's assigned to that locality or above. For localities of 1 or above, these are limited to specific OS kernel components and the processor itself (which theoretically cannot be attacked).

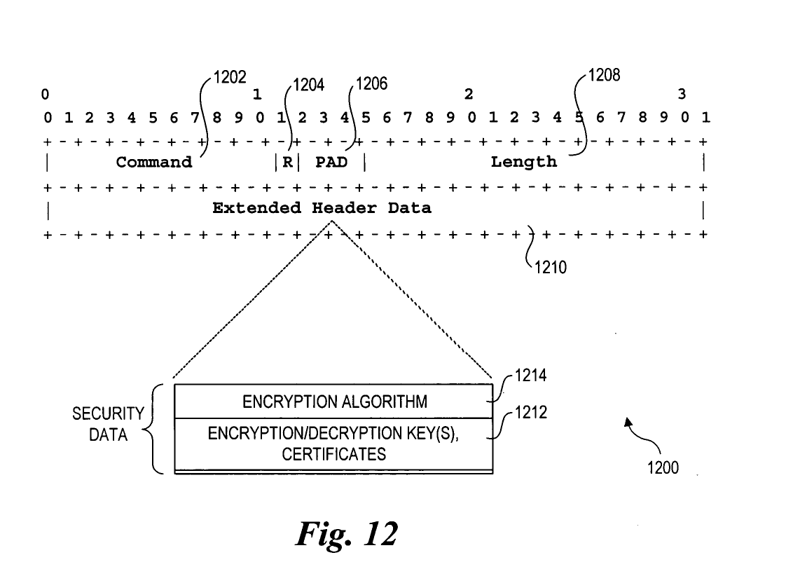

In accordance with one embodiment, security data may be delivered using a control burst. Details of an extended header 1200 employed by one embodiment as a mechanism for distributing security data via a control burst are shown in FIG. 12. The existence of an extended header is indicated by having the extended header (EH) field 606 off the generic PBS frame 500 set to “1” (FIGS. 5 and 6). The extended header 1200 includes a Command field 1202, a reserved (R) field 1204, a PAD field 1206, a Length field 1208 and extended header data 1210. The Command field 1202 identifies the Command carried by the extended header 1200, as described below. In the illustrated embodiment, the Command field is 12 bits.

The reserved field 1204 comprises a 1-bit field that is reserved for future use.

The PAD field 1206 identifies the number of padding byes that might be necessary to pad the last word of the extended header to comprise a 32-bit word. In the illustrated embodiment, PAD field 1206 comprises 3 bits.

The Length field 1208 defines the length of extended header 1200 in (32-bit) words, including the Command/Length word of the extended header. The minimum length is “1”, which corresponds to cases in which commands are provided that do not include any associated data (i.e., extended header data 1210).

The extended header data 1210 comprises a variable-length field (as defined by the Length field 1208) and may include up to three bytes of padding. In general, the extended header data will include security data, such as encryption and/or decryption keys 1212 (either symmetric or asymmetric) or data from which a decryption key can be derived. For example, in one embodiment the security key itself is encrypted using an encryption key known to a particular destination edge node or all of the edge nodes in a given PBS network. In this embodiment, even if the decryption key is somehow stolen, the acquiring entity will not be able to decrypt the data contained in the data bursts that are subsequently forwarded along the route reserved by the control burst.

In one embodiment, extended header data 1210 further includes data indicating the encryption algorithm that was employed to encrypt the data, as depicted by an encryption algorithm field 1214. For instance, a decryption key is useless if the encryption algorithm isn't known. For PKI encryption, the RSA encryption algorithm is most commonly used. Other encryption algorithms may also be used, including but not limited to the DES (Data Encryption Standard) algorithm (56-bit key), DES3 (Triple DES), RC2-40, RC2-64 and RC2-128 algorithms (40-, 64-, and 128-bit, respectively), RC4 algorithms, AES (Advanced Encryption Standard) algorithms, MD5 (Message Digest Algorithm) and SHA-1 (Secure Hash Algorithm). Furthermore, proprietary encryption schemes may also be employed. For implementations under which the encryption algorithm is known in advance, the encryption algorithm field 1214 may be dropped.

In general, encryption and decryption operations may be performed by software algorithms running on a processing core (e.g., a general-purpose processor or a network processor, for example), or may be performed via hardware that is programmed to perform the algorithms. In the case of software-based algorithms, the code for the algorithm may be provided by encryption algorithm 1214, or encryption algorithm 1214 may be used to identify the algorithm to be used, as described below in further detail.

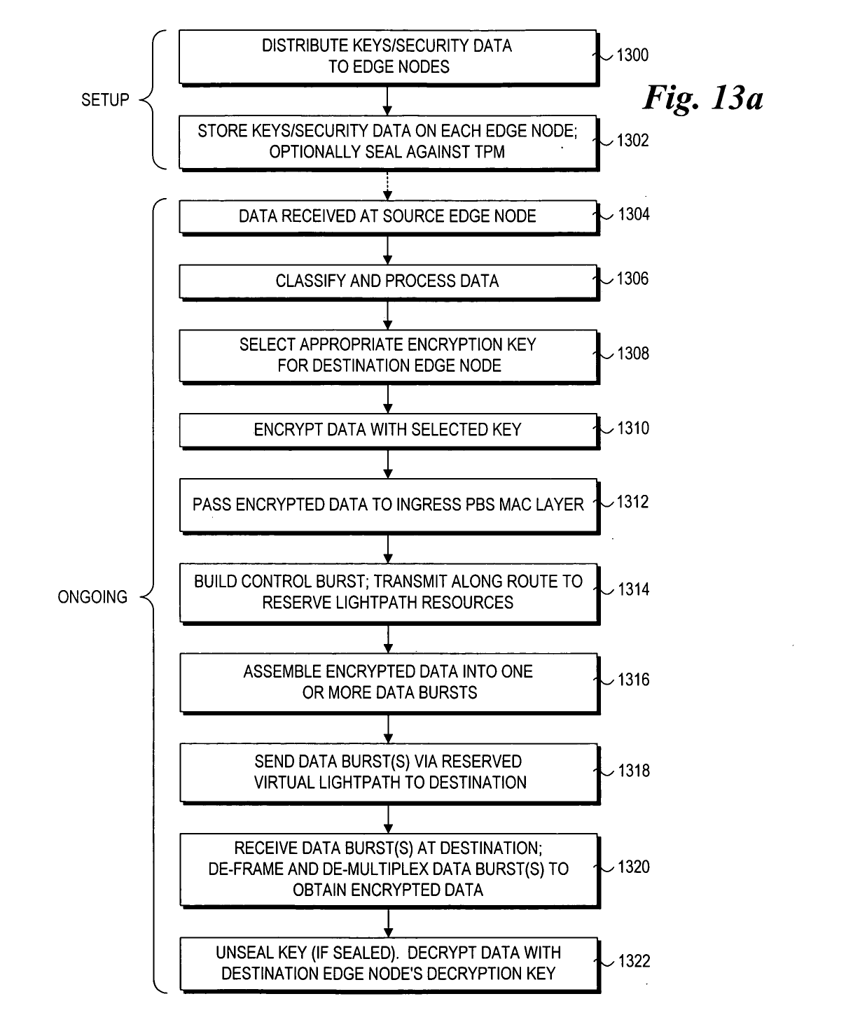

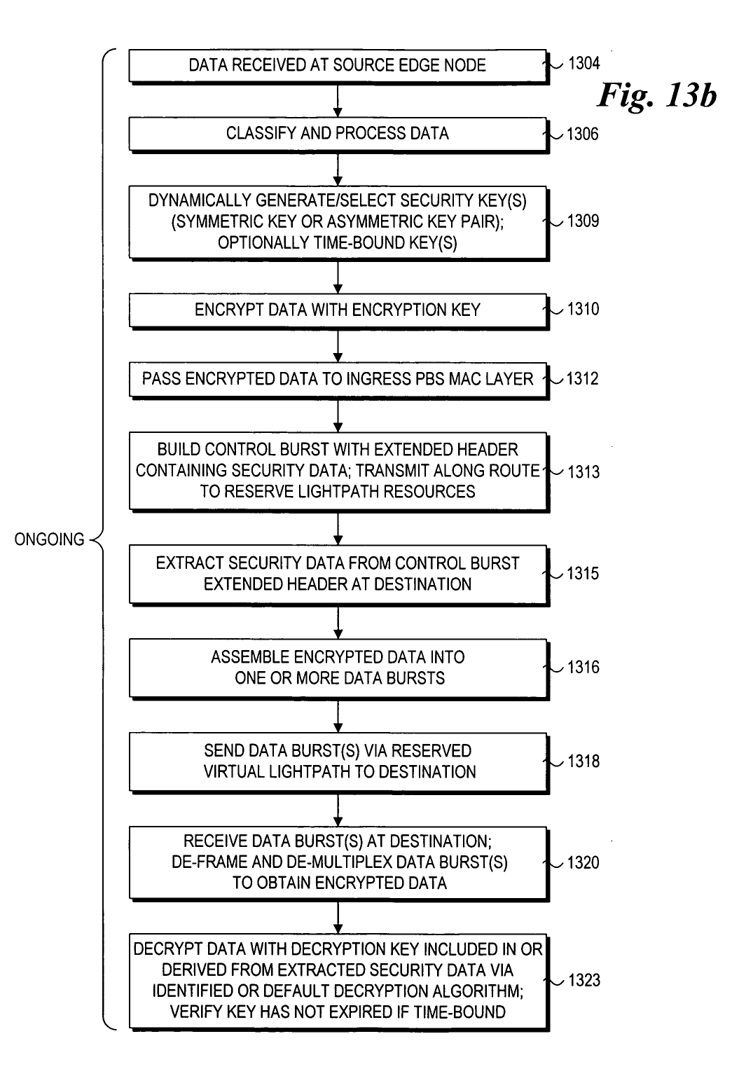

FIG. 13a shows a flowchart including operations performed to securely transmit data across a PBS network, according to one embodiment. The process involves two phases: a setup phase that is performed first, and than a subsequent ongoing phase.

The setup phase is used to provide appropriate keys and optional additional security data, such as algorithm code, to each of the edge nodes in the PBS network, and to set up the edge nodes to use these data. Accordingly, in a block 1300 the keys and optional security data are distributed to the edge nodes. In different respective embodiments, the distribution schemes of FIGS. 9a-b, 9c and 9d are employed. For distribution schemes that employ external links (e.g., Ethernet), the various data are encapsulated in the forwarding data structures used by the network protocol, such as packets or Ethernet frames. For distribution via a PBS network OOB channel, the data are forwarded using control burst that include extended header 1200, wherein the security data are included in extended header data 1210. In addition to these schemes, any suitable scheme for distributing asymmetric key pairs may be employed.

Once the keys and optional security data are received at a given edge node, corresponding data are stored on that node. For example, in one embodiment the data are stored in memory. In another embodiment, the data are stored in a non-volatile (NV) store, such as a flash device or a local mass storage device. Other setup operations may also be performed, such as setting up pointers to the locations of the keys. Optionally, a key (or certificate containing the key) may be stored in an encrypted form using an encryption key that is sealed to an edge node's TPM using the scheme discussed above.

The remaining operations shown in FIG. 13a related to ongoing operations that may be performed after the setup operations have been completed. First, in a block 1304, the data to be transmitted across the PBS network are received at a source edge node. The data are then classified and processed in the manner described above, as depicted by a block 1306. In a block 1308, an appropriate encryption key for the destination node is selected. For example, in the embodiments of FIGS. 9a-b, 9c, and 9d, there is an encryption key (i.e., K_{Encrypt-n} or K_{Pub-n}) that is stored at each edge node that is particular to the destination node; in this case, that particular encryption key is selected.

After the encryption key is selected, it is used to encrypt the data in a block 1310. The encrypted data is then passed to the ingress PBS MAC layer to be processed in the same manner discussed above for “regular” data. That is, from the perspective of the PBS MAC layer, encrypted and non-encrypted data are indistinguishable. Accordingly, the operations performed by the PBS MAC layer are the same as before. These include building a control burst in a block 1314. The control burst is used to reserve network resources to support all of the lightpath segments (i.e., hops) along a virtual lightpath for a future variable-length timeslot. The control burst may also contain information identifying whether or not the following associated data burst are encrypted or not, and what decryption algorithm is to be used (if a default algorithm is not employed or is not known in advance). For example, in one embodiment the DE field 520 of generic PBS frame 500 is asserted (e.g., marked with a “1”) to indicate the control burst contains security-related data (i.e., encryption will be enabled for the corresponding data bursts) or for security data distribution purposes.

In a block 1316, the encrypted data are assembled into one or more data bursts, as needed. In one embodiment, generation of data bursts coincides with generation of the corresponding control burst, wherein the operations of blocks 1314 and 1316 are performed together. One or more data bursts are sent from the source edge node to the destination edge node based on the selected scheduling algorithm and the reserved lightpath resources. The received data burst(s) is/are then de-framed and de-multiplexed in a block 1320, yielding the encrypted data. The encrypted data is then decrypted with the destination node's decryption key and identified algorithm (or default algorithm) in a block 1322. If the decryption key is stored in an encrypted form, the TPM_Unseal-related operations of FIG. 11b are employed to obtain the decryption key prior to decrypting the encrypted data.

In accordance with another aspect of the embodiments, security keys may be dynamically generated or selected, with an encryption key used to encrypt data at a source node. A corresponding decryption key (or data from which the decryption key can be derived) is included in an extended header of a control burst, and thus is forwarded to the destination edge node when the control burst is sent from the source node. This decryption key is then used to decrypt the encrypted data.

Further details of one embodiment of this key generation and forwarding scheme are shown in the flowchart of FIG. 13b. It is noted that many of the operations shown in FIG. 13b and analogous to those shown in FIG. 13a, wherein the like operations share the same reference numbers. For sake of brevity, details of those operations are not repeated below.

The process starts in a similar manner to the embodiment of FIG. 13a, wherein data received at a source edge node is classified and processed, as depicted by block 1304 and 1306. In a block 1309, a symmetric security key or pair of asymmetric security keys are dynamically generated or selected. For example, a symmetric key may be generated using a random number generator or the like. Such an operation may be performed by a hardware device or via an algorithm executed on a processor or the like. An asymmetric key pair may also be generated via hardware or an algorithm. In one embodiment, a symmetric key or the asymmetric key pair is dynamically generated by a TPM.

In addition to dynamic generation of keys, a symmetric key or asymmetric key pair may be selected from a set of keys stored at the edge node. For example, an edge node could store 10's or even 100's of symmetric keys or asymmetric key pairs. In general, the key or keys are selected without consideration of the identity of the destination node, such as via a random numbering scheme (e.g., using R modulo n, where R is a random number and n represents the number of keys of key pairs).

In one embodiment, the dynamically generated keys are time-bound. In other word, a key is only viable for a specified time-frame, after which it expires and cannot be used. In one embodiment, the time-frame is encoded in the key, and an augmented encryption/decryption algorithm is employed that first evaluates the key to see if it has not expired. In another embodiment, the time-frame information is passed as part of the security data in the extended header via a control burst. The use of time-bound security keys prevents the keys that were previously sent and used for past transfer sessions to be used for decryption in subsequent sessions. For example, under a key selection scheme, the same key(s) may be selected for repeated use on an intermittent basis.

After the symmetric key or asymmetric key pair are generated or selected, the data is encrypted with the encryption “half” of the key(s) in a block 1310. For instance, under symmetric key cryptography, the same key is used for both encryption and decryption. For an asymmetric key pair, the encryption key is used for encryption while the decryption key is used for decryption. Upon being encrypted, the data are passed to the ingress PBS MAC layer of the source edge node in block 1312.

Next, in a block 1313, a control burst including an extended header 1200 containing security data is built. As discussed above, a control burst is built and sent along a selected lightpath to reserve network resources for a future variable-length timeslot. In this instance, the security data will typically include the generated or selected decryption key. Optionally, information identifying the encryption algorithm that was used to encrypt the data may also be included.

After the control burst with extended header is built, it is transmitted from the source to destination edge node along the lightpath route that is to be reserved for the subsequent transmission of data burst, completing the operations of block 1313. The key data are then extracted from the control burst extended header at the destination edge node in a block 1315. Subsequently, the operations of blocks 1316, 1318 and 1320 are performed in a manner analogous to the like-labeled blocks of FIG. 13a discussed above. The data are then decrypted in a block 1323 using the decryption key and specified (or default) algorithm defined by the security data extracted in block 1315.

In the event the key is time-bound, a determination of whether the key as expired or not is made prior to allowing decryption to be performed. If the key has expired, the decryption operations of block 1323 are not performed.

The hardware for performing the various operations for the edge nodes discussed above may be embodied in one of many different platform configurations. For example, in one embodiment one or more server modules are housed within a server unit, such as a blade server or the like. In another embodiment, all of an edge node's functionality may be provided by a single card or server module.

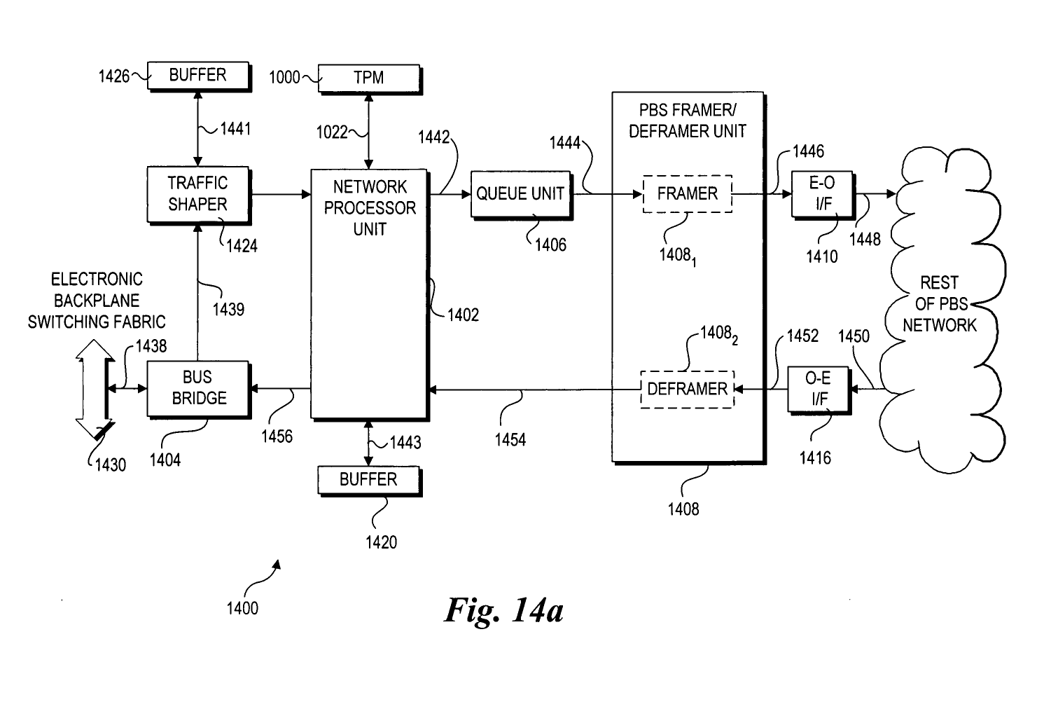

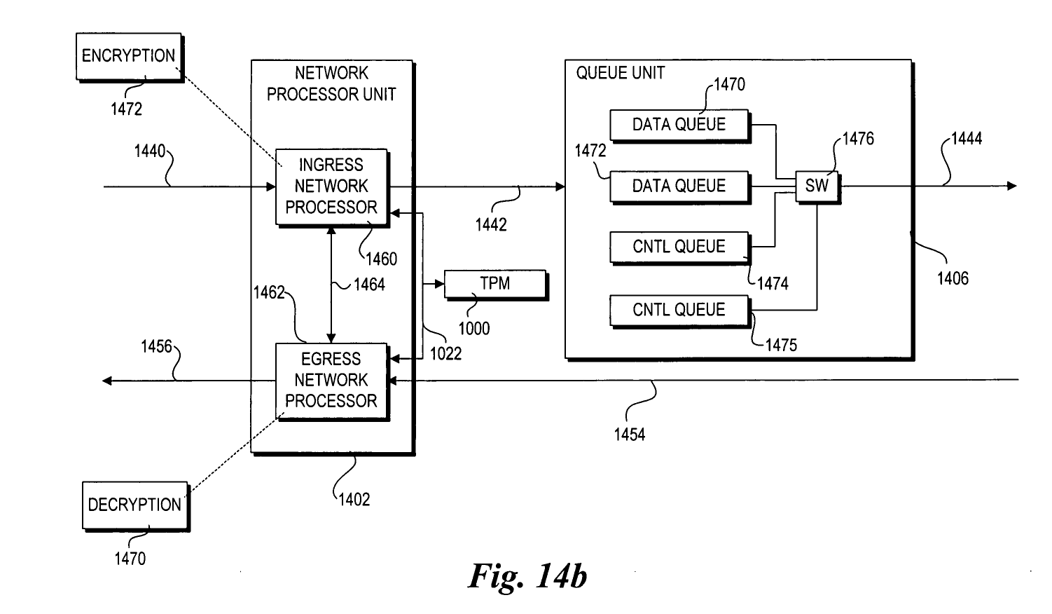

For example, FIG. 14a illustrates optical PBS I/O module 1400, according to one embodiment of the present invention. In this embodiment, optical PBS I/O module 1400 includes a network processor unit 1402 (this module could have multiple network processors), a bus bridge 1404, a queue unit 1406, a framer unit 1408 (having framer and de-framer functions as indicated by blocks 1408, and 14082), an E-O interface 1410, an O-E interface 1416, a network processor buffer 1420, a traffic shaper 1424, a traffic shaper buffer 1426, and a TPM 1000. PBS I/O module 1400 further includes a backplane switching fabric 1430, which in one embodiment comprises a PCI Express bus, although any other suitable buses may be used in other embodiments. Thus, bus-bridge 1404 can be implemented using a commercially available PCI bridge device or chip set.

In the illustrated embodiment, the foregoing elements of optical PBS I/O unit 1400 are interconnected as follows. Bus bridge 1404 is connected to backplane switching fabric 1430 to support parallel bi-directional traffic via interconnect 1438. Bus bridge 1404 is also connected to traffic shaper 1424 via an electrical interconnect 1439. Electrical interconnects 1438, 1439 and other signal interconnects in FIG. 14a are depicted as single interconnect wire (even though the connection may include several signal interconnect wires) for clarity.

Traffic shaper 1424 is connected to network processor unit 1402 and buffer 1426 via interconnects 1440 and 1441, respectively. Network processor unit 1402 is connected to queue unit 1406 and buffer 1420 via interconnects 1442 and 1443, respectively. Network processor unit 1402 is connected to TPM 1000 via an LPC bus 1022. Queue unit 1406 is in turn connected to PBS framer/de-framer unit 1408 via an interconnect 1444.

As shown in FIG. 12b, in some embodiments network processor unit 1402 includes an ingress network processor 1460 and an egress network processor 1462. Thus, in some embodiments of optical PBS I/O module 1400, interconnects 1440 and 1442 are connected to ingress network processor 1460. In one embodiment, each of ingress network processor 1460 and egress network processor 1462 are connected to TPM 1000 via LPC bus 1022. In other embodiments, the TPM may be connected to either of ingress network processor 1460 and egress network processor 1462 on an individual basis.

Further, as shown in FIG. 14b, in some embodiments, queue unit 1406 can include data queues 1470 and 1472, control queues 1474, and 1475 and an electrical switch or demultiplexer 1476 coupled to the output ports of queues 1470, 1472, 1474 and 1475. Thus, in some embodiments, the input ports of queues 1470, 1472, 1474 and 1275 are connected to interconnect 1442 via a switch or multiplexer (not shown). In addition, in some embodiments, the output port of switch 1476 can be connected to interconnect 1444.

In other embodiments, a different number of processors (e.g., a single processor) can be used in network processor unit 1402. Further, in some embodiments, a different number of queues can be used in queue unit 1406. For example, queue unit need not include a dedicated control queue and/or two data queues. Multiple queues can be used to provide storage for building multiple bursts with different properties such as different priorities. In general, buffers 1420 and 1426 will be embodied as some form of memory, such as dynamic random access memory (DRAM) or static random access memory (SRAM).

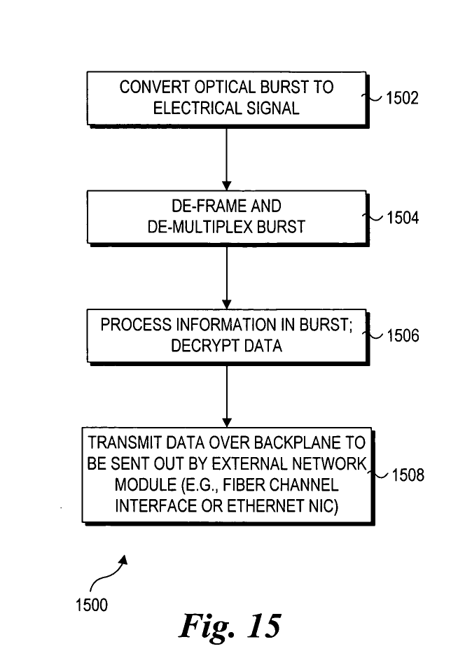

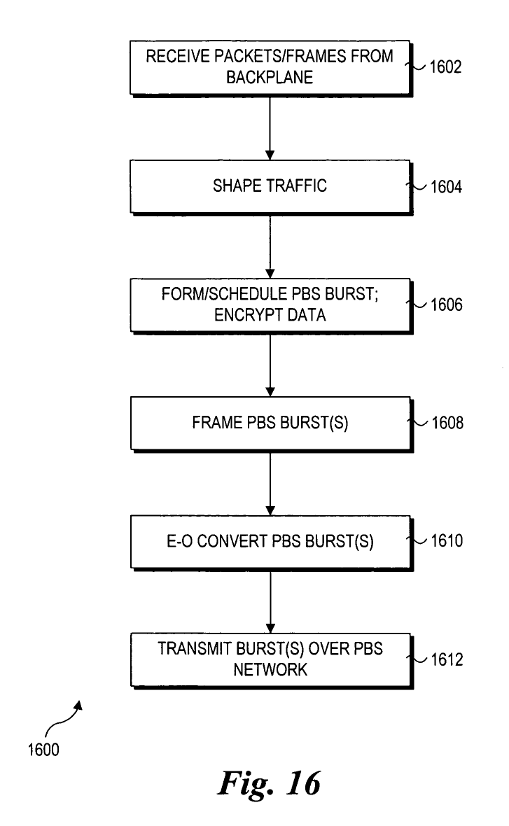

Referring again to FIG. 14a, PBS framer unit 1408 is connected to E-O interface 1410 via an interconnect 1446. E-O interface 1410 is in turn is connected to the rest of a PBS network via an interconnect 1448. O-E interface 1416 connected to the rest of the PBS network via a interconnect 1450. In general, O-E interface 1416 can receive all the transmitted wavelengths on an interconnected external network, such as a server and/or storage area network (SAN)—either it has a tunable optical burst receiver or multiple fixed wavelength optical burst receivers. O-E interface 1416 is also connected to framer unit 1408 via an interconnect 1452. Framer/de-framer unit 1408 is also connected to network processor unit 1402 via a interconnect 1454. In one embodiment, an interconnect 1454 is connected to network processor 1462 (FIG. 14b). Network processor unit 1402 is connected to bus bridge 1404 via an interconnect 1456. The operation of optical PBS I/O module 1400 in transferring information to and from the PBS network is described below in conjunction with FIGS. 15 and 16.

Referring to FIGS. 14a-b and a flowchart 1500 of FIG. 15, optical PBS I/O module 1400 performs PBS egress operations (i.e., transferring information from the PBS network to a legacy network and/or server module of a server unit) as follows. Optical PBS I/O module 1400 converts an optical PBS burst received from the PBS network via an interconnect 1450 into electrical signals. In this embodiment, O-E interface 1416 performs the O-E conversion. This operational flow is represented by a block 1502.

The received O-E converted PBS burst is then de-framed and de-multiplexed. In this embodiment, framer/de-framer unit 1408 receives the O-E converted PBS burst from O-E interface 1416 via interconnect 1452 and de-frames the PBS burst. For example, in one embodiment, the PBS burst may be framed as described above with reference to FIGS. 5 and 6. In other embodiments, a different framing format may be used. De-multiplexing enables each framed data burst to be separated into the corresponding IP packets, Ethernet fames, Fiber Channel (FC) frames, etc. This operational flow is represented by a block 1504.

The information included in the PBS burst is then processed. In this embodiment, network processor unit 1402 receives the de-framed and de-multiplexed PBS burst from framer/de-framer unit 1408 via interconnect 1454 and performs the processing. For example, in some embodiments, network processor unit 1402 can extract address and payload information, perform error correction on header and/or payload information, concatenate a payload, re-assemble segmented payloads, etc. Network processor unit 1402 can use buffer 1420 to temporarily store information during the above processing operations. In one embodiment, egress network processor 1462 (FIG. 14b) processes the de-framed burst.

Another aspect of processing is decryption. As discussed above, this can be performed by software executing on a processor or the like such as network processor unit 1402. Optional, this may be performed by dedicated hardware. Both embodiments are depicted as a decryption block 1470 in FIG. 14b. The processing and decryption operations are represented by a block 1506.

The processed and decrypted information is then transmitted over backplane switching fabric 1430. In one embodiment, bus bridge 1404 receives the processed information from network processor unit 1402 via an interconnect 1456 and transmits the information over backplane switching fabric 1430 to the proper destination, in the proper format, and with proper bus control signals (e.g., according to the PCI protocol). The destination for the information may be, for example, a device connected to the legacy network (in which case the information is transmitted to a legacy interface module not shown or a server module (both not shown)). For example, a legacy interface might comprise an Ethernet NIC or a Fiber Channel interface. This operational flow is represented by a block 1508.

Referring to FIGS. 14a-b and a flowchart 1600 of FIG. 16, optical PBS I/O module 1400 performs PBS ingress operations; i.e., transferring information to the PBS network from a legacy network and/or server module of a server unit as follows. Optical PBS I/O module 1400 receives information to be transmitted over a PBS network in the form of electrical signals. In one embodiment, bus bridge 1404 receives the information from backplane switching fabric via an interconnect 1438. In this embodiment, this information can come from the legacy network via a legacy interface or from one of various server modules (both not shown). This operational flow is represented by a block 1602.

The received information is then shaped to help improve traffic flow in the PBS network (e.g., PBS network 110 of FIG. 1). In this embodiment, traffic shaper 1424 receives the information from bus bridge 1404 via interconnect 1439 and shapes the information. For example, in one embodiment, traffic shaper 1424 performs operations on the information to reduce the correlation structures and long-term dependence of the incoming traffic flows caused by the self-similarity effect. Traffic shaper 1424 can be configured to perform any suitable traffic-shaping algorithm or technique known in the art. Traffic shaper 1424 can use buffer 1426 to temporarily store information while performing traffic shaping operations. This operational flow is represented by a block 1604.

The shaped information is then multiplexed into PBS control and data bursts. In this embodiment, network processor unit 1402 receives the shaped information from traffic shaper 1424 via interconnect 1440. Network processor unit 1402 then processes the information to form and schedule PBS control and data bursts as described above for ingress nodes in PBS network 10A. In other embodiments, the information is assembled into suitable burst sizes based on the selected burst assembly algorithms to be transmitted over an optical burst network (not necessarily a PBS network). In one embodiment, ingress network processor 1460 (FIG. 14b) processes the traffic shaped information. Further, in this embodiment, network processor unit 1402 uses queue unit 1406 to store the control and data bursts as they are being formed and until they are scheduled for transmission over the PBS network. This operational flow is represented by a block 1606.

Another aspect of the operational flow of block 1606 relates to security operations. For instance, this includes data encryption for the data payload and formatting the PBS burst to identify whether encryption is used in the associated data burst, what algorithm to employ, etc. As with data decryption, data may be encrypted using a software-based algorithm or may be performed using an appropriately programmed hardware device. Both of these embodiments are depicted as an encryption block 1472.

The encrypted data bursts are then encapsulated into frames for transmission over the PBS network. In this embodiment, framer unit 1408 receives the bursts from queue unit 1406 via interconnect 1444 and performs the framing operation. In one embodiment, the bursts are framed as described above with reference to FIGS. 5 and 6. In other embodiments, different framing formats can be used. This operational flow is represented by a block 1608.

The framed bursts are then converted to optical signals and transmitted over the PBS network at the scheduled times. In this embodiment, E-O interface 1410 receives the framed bursts (i.e., PBS control and data bursts) from framer unit 1408 via interconnect 1446. E-O interface 1210 then performs the E-O conversion and transmits the optical signals at the scheduled time and in the reserved PBS TDM channel of the PBS network. This operational flow is represented by blocks 1610 and 1612.

In general, the encryption/decryption functionality may be provided by a separate module (as depicted by decryption block 1470 and encryption block 1472 in FIG. 14b), or may be integrated onto an existing component of PBS architecture 400 (FIG. 4). As with the foregoing PBS switching node and edge node functionality, the encryption/decryption functionality can be implemented via hardware (e.g., programmed logic), software, or a combination of the two. More specifically, software for implementing PBS switching node and edge node functionality may be embodied as one or more sets of instructions or modules including instructions that are executed on some form of processor core, such as a network processor, processor of a server or I/O module, or other type of processor. In addition, the code (i.e., instructions) corresponding to such software will generally be loaded into memory prior to execution. Furthermore, during ongoing operations the instructions may be stored in a processor cache, or a secondary cache.

Thus, embodiments of this invention may be used as or to support software program executed upon some form of processing core or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

In the foregoing specification, embodiments of the invention have been described. It will, however, be evident that various modifications and changes may be made thereto without departing from the broader spirit and scope as set forth in the appended claims. The specification and drawings are, accordingly, to be regarded in an illustrative rather than a restrictive sense.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

1. A method for securely transferring data across an optical-switched (OS) network, comprising:
generating, at least one edge node in the OS network, security keys including an encryption key and a decryption key;
distributing, for said at least one edge node, the encryption key to at least one other edge nodes in the OS network;
encrypting, at a source edge node, data to be sent from the source edge node to a destination edge node, said data encrypted with an encryption key distributed by the destination node and received by the source node;
sending the data along a virtual lightpath between the source and destination edge nodes, the virtual lightpath spanning at least one lightpath segment; and
decrypting, at the destination edge node, the encrypted data that are sent, said encrypted data being decrypted with the decryption key generated by the destination node.

2. The method of claim 1, wherein the OS network comprises an optical burst-switched (OBS) network.

3. The method of claim 2, wherein the OBS network comprises a photonic burst-switched (PBS) network.

4. The method of claim 2, wherein the PBS network comprises a wavelength-division multiplexed (WDM) PBS network.

5. The method of claim 1, wherein the security keys are generated and distributed by:
generating a respective asymmetric key pair including an encryption and decryption key at each edge node in the OS network; and
for each edge node,
distributing the encryption key it generated to each of the other edge nodes.

6. The method of claim 1, wherein the encryption key comprises a public key and the decryption key comprises a private key, and wherein security keys are distributed by:
for at least one edge node;
receiving a digital certificate at a receiving edge node, the digital certificate containing a public key corresponding to a private key generated by a generating edge node, wherein the public key is to be used to encrypt data send from the receiving edge node to the generating edge node.

7. The method of claim 6, further comprising:
generating a self-signed digital certificate at the generating edge node; and
sending the digital certificate to the receiving edge node.

8. The method of claim 6, further comprising:
generating security data including the public key at the generating edge node;
sending the security data to a certificate authority, the certificate authority to issue an authenticated digital certificate containing the public key; and
receiving the authenticated digital certificate at the receiving edge node.

9. The method of claim 8, further comprising:
generating a respective set of security data at each edge node; and
sending the respective set of security data from each edge node to the certificate authority.

10. The method of claim 1, further comprising:
employing a trusted platform module (TPM) to generate an asymmetric key pair comprising the encryption key and the decryption key.

11. The method of claim 10, further comprising:
employing the TPM to securely store the decryption key in a manner by which it cannot be accessed by an unauthorized agent.

12. The method of claim 11, wherein the decryption key is securing stored by performing operations including:
dynamically generating a security key with the TPM;
encrypting one of a decryption key or a digital certificate containing a decryption key using the security key;
measuring an integrity metric corresponding to a platform configuration;
storing the integrity metric in a platform configuration register (PCR) sealing the security key against the TPM using a TPM_Seal command referencing the PCR.

13. The method of claim 1, further comprising:
employing a trusted platform module (TPM) accessible to edge node that receives an encryption key to securely store the encryption key in a manner by which it cannot be accessed by an unauthorized agent.

14. The method of claim 1, further comprising sending encryption keys to said at least one other edge node using a communication channel that is external to the OS network to distribute the security keys.

15. The method of claim 1, further comprising sending encryption keys to said at least one other edge node using an out-of-band channel of the OS network to distribute the security keys.

16. The method of claim 15, further comprising sending security data via a control burst for the OS network, the security data including one or more security keys or containing information from which one or more security keys can be derived.

17. The method of claim 1, further comprising sending information to each edge node identifying at least one of an encryption algorithm and decryption algorithm to be employed to encrypt and/or decrypt the data via the security keys.

18. The method of claim 17, further comprising sending encryption and/or decryption code to an edge node, the encryption and/or decryption code to be executed to perform encryption and/or decryption operations.

19. A method for securely transferring data across an optical-switched (OS) network, comprising:
performing one of dynamically generating or selecting an encryption and decryption key at a source edge node in the OS network;
building a control burst, the control burst containing information to reserve network resources to form a virtual lightpath between the source edge node and a destination edge node during a scheduled timeslot, the virtual lightpath including at least one lightpath segment, the control burst further including security data comprising one of the decryption key or data from which the decryption key can be derived;
sending the control burst to the destination edge node;
encrypting, at a source edge node, data to be sent from the source edge node to a destination edge node, said data encrypted with the encryption key;
sending the encrypted data along the virtual lightpath between the source and destination edge nodes during the timeslot for which the virtual lightpath is reserved, and
decrypting, at the destination edge node, the encrypted data that are sent, said encrypted data being decrypted with a decryption key comprising one of the decryption key include with the security data sent via the control burst or a decryption key derived from the security data.

20. The method of claim 19, wherein the OS network comprises an optical burst-switched (OBS) network.

21. The method of claim 20, wherein the OBS network comprises a photonic burst-switched (PBS) network.

22. The method of claim 20, wherein the PBS network comprises a wavelength-division multiplexed (WDM) PBS network.

23. The method of claim 19, further comprising:
dynamically generating the encryption and decryption keys using a trusted platform module located at the source edge node.

24. The method of claim 23, wherein the encryption and decryption keys comprises a single symmetric key.

25. The method of claim 23, wherein the encryption and decryption keys comprises an asymmetric key pair.

26. The method of claim 19, further comprising:
time-bounding the decryption key so the decryption key will expire after a pre-defined timeframe; and
determining if the decryption key has expired prior to enabling the data to be decrypted at the destination edge node, wherein decryption is not allowed if the decryption key has expired.

27. The method of claim 19, wherein the security data sent via the control burst further includes information identifying an encryption algorithm to be employed to encrypt the data sent to the destination node.

28. A machine-readable medium to provide instructions, which when executed by a processor in a source edge node of an optical switched (OS) network cause the source edge node to perform operations including:
encrypting data to be sent to a destination edge node using an encryption key;
generating a control burst, the control burst containing information to reserve network resources to form a virtual lightpath between the source edge node and the destination edge node during a scheduled timeslot, the virtual lightpath including at least one lightpath segment, the control burst further including security data comprising one of a decryption key or data from which the decryption key can be derived;
sending the control burst to the destination edge node; and
sending one or more data bursts containing the data that are encrypted to a first hop along the virtual lightpath during the scheduled timeslot.

29. The machine-readable medium of claim 28, wherein execution of the instructions further perform the operation of generating one of a symmetric session key or an asymmetric session key pair, the session key or key pair including the encryption key and the decryption key.

30. The machine-readable medium of claim 28, wherein execution of the instructions performs the further operation of sending a command to a trusted platform module (TPM) to generate a symmetric session key or an asymmetric session key pair, the session key or key pair including the encryption key and the decryption key.

31. The machine-readable medium of claim 28, wherein execution of the instructions performs the further operation of selecting a symmetric session key or an asymmetric session key pair for a set of security keys which may be accessed by the source edge node.

32. The machine-readable medium of claim 28, wherein execution of the instructions performs the further operation of embedding information in the control burst identifying said one or more data bursts to be sent from the edge node to the destination edge node will be encrypted.

33. The machine-readable medium of claim 28, wherein the security data include one of information identifying an encryption algorithm used to encrypt the data or executable code that may be used to decrypt the certificate.

34. A system comprising:
at least one processor;
memory communicatively-coupled to said at least one processor;
an encryption component;
a trusted platform module (TPM), communicatively-coupled to said at least one processor;
an optical interface; and
a storage device in which instructions are stored, said instructions to perform operations when executed by said at least one processor, including:
commanding the TPM to generate one of a symmetric session key or an asymmetric session key pair, the session key or key pair including an encryption key and a decryption key.
invoking the encryption component to encrypt, using the encryption key, data to be sent to a destination edge node operatively linked in communication to the system via a photonic burst-switched (PBS) network, the system to operate as a source edge node;
generating a control burst, the control burst containing information to reserve PBS network resources to form a virtual lightpath between the source edge node and the destination edge node during a scheduled timeslot, the virtual lightpath including at least one lightpath segment, the control burst further including security data comprising one of the decryption key or data from which the decryption key can be derived;
sending the control burst to a first hop along the virtual lightpath, the first hop comprising one of a switching node or the destination edge node; and
sending one or more data bursts containing the data that are encrypted to a first hop along the virtual lightpath during the scheduled timeslot.

35. The system of claim 34, wherein said at least one processor includes a network processor.

36. The system of claim 34, wherein said at least one processor includes an ingress network processor and an egress network processor.

37. The system of claim 34, wherein the encryption component comprises a hardware device programmed to perform encryption operations.

38. The system of claim 34, wherein the encryption component is embodied as a software module comprising a plurality of instructions to effectuate encryption operations when executed on a processor.

39. The system of claim 34, further comprising a decryption component configured to decrypt data received from the PBS network.

40. The system of claim 39, wherein the decryption component comprises a hardware device programmed to perform decryption operations.

41. The system of claim 39, wherein the decryption component is embodied as a software module comprising a plurality of instructions to effectuate decryption operations when executed on a processor.

42. The system of claim 39, wherein the decryption component is used to determine if a time-bound decryption key has expired prior to enabling the data to be decrypted, wherein decryption is not allowed if the decryption key has expired

43. The system of claim 34, wherein execution of the instructions by said at least one processor further performs the operation of embedding information in the control burst identifying said one or more data bursts to be sent from the edge node to the destination edge node will be encrypted.

44. The system of claim 34, wherein execution of the instructions by said at least one processor further performs the operation of time-bounding the decryption key such that the encryption key will expired after a pre-determined timeframe.
